(19) United States
(12) Patent Application Publication
(10) Pub. No.: US 2026/0367365 A1
(43) Pub. Date: Nov. 19, 2026

(54) OPTICAL SYSTEM AND CAMERA MODULE

(71) Applicant: LG INNOTEK CO., LTD., Seoul (KR)

(72) Inventor: Doo Shik SIN, Seoul (KR)

(73) Assignee: LG INNOTEK CO., LTD., Seoul (KR)

(21) Appl. No.: 19/148,182

(22) PCT Filed: Jan. 17, 2024
(86) PCT No.: PCT/KR2024/000868

§ 371 Date: Jul. 15, 2025

(30) Foreign Application Priority Data
Jan. 17, 2023 (KR) 10-2023-0006848

(51) Int. Cl. G02B 13/18; G02B 15/14

(52) U.S. Cl. CPC G02B 13/18; G02B 15/143105

(57) ABSTRACT

The optical system disclosed in the embodiment of the invention includes first to third lens groups arranged along an optical axis and each including at least one lens, wherein the first lens group and the third lens group have positive power, the second lens group has negative power, a position of the first lens group is fixed, each of the second and third lens groups moves along the optical axis according to an operation mode, a first lens of the first lens group closest to an object has positive power, an optical axis distance of the second lens group is greater than an optical axis distances of the first and third lens groups, a number of lenses of the third lens group is smaller than a number of lenses of the first lens group, and the third lens group may include a lens having a meniscus shape convex toward a sensor side and a meniscus shape convex toward an object side.

### TECHNICAL FIELD

An embodiment of the invention relates to an optical system for improved optical performance and a camera module including the same.

### BACKGROUND ART

The camera module captures an object and stores it as an image or video, and is installed in various applications. In particular, the camera module is produced in a very small size and is applied to not only portable devices such as smartphones, tablet PCs, and laptops, but also drones and vehicles to provide various functions. For example, the optical system of the camera module may include an imaging lens for forming an image, and an image sensor for converting the formed image into an electrical signal. In this case, the camera module may perform an autofocus (AF) function of aligning the focal lengths of the lenses by automatically adjusting the distance between the image sensor and the imaging lens, and may perform a zooning function of zooming up or zooning out by increasing or decreasing the magnification of a remote object through a zoom lens. In addition, the camera module employs an image stabilization (IS) technology to correct or prevent image stabilization due to an unstable fixing device or a camera movement caused by a user's movement.

The most important element for this camera module to obtain an image is an imaging lens that forms an image. Recently, interest in high efficiency such as high image quality and high resolution is increasing, and research on an optical system including plurality of lenses is being conducted in order to realize this. For example, research using a plurality of imaging lenses having positive (+) and/or negative (−) refractive power to implement a high-efficiency optical system is being conducted. When the optical system includes a plurality of lenses, there is a problem in that it is difficult to derive excellent optical properties and aberration properties. In addition, when a plurality of lenses is included, the overall length, height, etc. may increase due to the thickness, interval, size, etc. of the plurality of lenses, thereby increasing the overall size of the module including the plurality of lenses.

A size of the image sensor is increasing to realize high-resolution and high-definition. However, when the size of the image sensor increases, TTL (Total Track Length) of the optical system including the plurality of lenses also increases, thereby increasing the thickness of the camera and the mobile terminal including the optical system.

When the optical system includes a plurality of lenses, the position of at least one lens or a lens group including at least one lens may be controlled to perform functions such as zoom and autofocus (AF). However, when the lens or the lens group performs the function, the amount of movement of the lens or the lens group can increase exponentially. Accordingly, the optical system has a problem in that a lot of energy may be required for the movement of the lens or the lens group, and a large volume is required in consideration of the amount of movement. In addition, there is a problem in that aberration characteristics deteriorate due to the movement of the lens or the lens group. Accordingly, there is a problem in that optical characteristics deteriorate at a specific magnification when performing the zoom and autofocus (AF) functions. Therefore, a new optical system capable of solving the above-described problems is required.

### DISCLOSURE

### Technical Problem

An embodiment of the invention provides an optical system having improved optical characteristics. The embodiment provides an optical system and a camera module capable of photographing at various magnifications. The embodiment provides an optical system and a camera module having improved aberration characteristics at various magnifications. The embodiment provides an optical system and a camera module that may be implemented in a small and compact manner.

### Technical Solution

An optical system according to an embodiment of the invention comprises first to third lens groups arranged along an optical axis from an object toward a sensor side and each lens group of which includes at least one lens, wherein the first lens group and the third lens group have positive power, the second lens group has negative power, a position of the first lens group is fixed, and each of the second and third lens groups moves along the optical axis according to an operation mode, a first lens of the first lens group closest to the object has positive power, an optical axis distance of the second lens group is greater than an optical axis distances of the first and third lens groups, a number of lenses of the third lens group is smaller than a number of lenses of the first lens group, and the third lens group may include a lens having a meniscus shape convex toward the sensor side and a meniscus shape convex toward the object side.

According to an embodiment of the invention, the lenses of the first to third lens groups are made of plastic, and the lenses of the first to third lens groups have a smaller number of lenses with negative power than a number of lenses with positive power.

According to an embodiment of the invention, the optical axis distances of the first to third lens groups are DG1, DG2, and DG3, and the following equations may satisfy: 0.5<DG1/DG2<1 and 0.8<DG1/DG3<1.

According to an embodiment of the invention, a lens having the largest absolute value of focal length among the first to third lens groups may be disposed in the third lens group. The optical axis distance of the third lens group is DG3, and an optical axis distance between the surface of the lens of the first lens group closest to the object side and an imaging surface of the image sensor is TTL, and the following equation may satisfy: 2<TTL/(DG2+DG3)<5.

According to an embodiment of the invention, an optical axis distance between a lens closest to the image sensor in the third lens group and the image sensor varies depending on the operation mode, and the operation mode of the optical system may include a wide mode, a middle mode, and a tele mode.

According to an embodiment of the invention, an optical axis distance between the object-side surface of the lens closest to the object in the first lens group and a sensor-side surface of the lens closest to the image sensor in the third lens group varies depending on the operation mode, and the optical axis distance between the first and second lens groups and the optical axis distance between the second and third lens groups may be at least 0.2 mm or more and at most 8 mm or less.

According to an embodiment of the invention, the wide mode is Md1, and an optical axis distance between the first and second lens groups in the wide mode is DG12, and an optical axis distance between the second and third lens groups is DG23, and the following equation may satisfy: 1<Md1 (DG12/DG23)<5. The tele mode is Md3, and an optical axis distance between the first and second lens groups in the tele mode is DG12, and the optical axis distance between the second and third lens groups is DG23, and the following equation may satisfy: 0<Md3 (DG12/DG23)<0.7.

According to an embodiment of the invention, the maximum distance between adjacent lenses according to the operation mode is Md_CG_Max, and the minimum distance between adjacent lenses according to the operation mode is Md_CG_Min, and the following equation may satisfy: 2<Md_CG_Max/Md_CG_Min<8.

According to an embodiment of the invention, the number of lenses of the first lens group is greater than the number of lenses of the second lens group, and an absolute value of a focal length of the first lens group may be more than twice a focal length of the second lens group. An effective focal length of the optical system in the wide mode is FMd1, the focal length of the first lens is F1, and the following equation may satisfy: 5<F1/Fmd1<13.

According to an embodiment of the invention, an effective focal length of the optical system in the tele mode is FMd3, and the following equation may satisfy: 0<F1/Fmd3<0.6. A field of view in the wide mode is FOV1, a field of view in the middle mode is FOV2, and a field of view in the tele mode is FOV3, and the following equation may satisfy: 8°<FOV3<FOV2<FOV1<45°.

An optical system according to an embodiment of the invention comprises: a first lens group having first to third lenses; a second lens group having fourth and fifth lenses; and a third lens group having sixth and seventh lenses, wherein the first lens group, the second lens group, and the third lens group are arranged in an optical axis direction from the object toward an sensor, the first lens has positive refractive power and has an object-side surface that is convex on the optical axis, the third lens has negative refractive power and has a biconcave shape on the optical axis, the fifth and sixth lenses have refractive powers of opposite signs and have a meniscus shape that is convex on the sensor side, the second lens group and the third lens group move in a direction of the optical axis, and an optical axis distance between the seventh lens and the image sensor is variable depending on the operation mode, and the first to seventh lenses have a number of lenses having a refractive index exceeding 1.60 greater than a number of lenses having a refractive index less than 1.60, and the refractive index of the second lens is Nd2, and may satisfy the equation: 1.65<Nd2.

According to an embodiment of the invention, the first and third lens groups may have negative (−) refractive power, and the second and fourth lenses may have positive refractive power. The fourth lens and the seventh lens may have refractive indices of less than 1.6. The lens surface having the largest absolute value of the radius of curvature of the object-side surface and the sensor-side surface of each of the first to seventh lenses may be the object-side surface of the third lens.

According to an embodiment of the invention, an effective length of the first lens is the largest among the lenses, and the maximum length of the first lens in a first direction and the maximum length of a second direction perpendicular to the optical axis may be different from each other. The effective length of the largest lens surface among the first to seventh lenses is CA_Max, and ½ of the diagonal length of the image sensor is ImgH, and the following equation may satisfy: 1<CA_Max/ImgH<3.

A camera module according to an embodiment of the invention comprises: an image sensor; an optical system; and a driving member for moving at least one of a plurality of lens groups of the optical system in a direction of the optical axis, wherein the optical system includes the optical system disclosed above, and the driving member may move positions of each of the second and third lens groups of the optical system in the direction of the optical axis.

### Advantageous Effects

An optical system and camera module according to the embodiment have various magnifications and may have excellent optical characteristics when providing various magnifications. In detail, the embodiment can control the movement distance of each of the moving lens groups to have various magnifications and provide an autofocus (AF) function for the subject. The optical system and camera module according to the embodiment can compensate for aberration characteristics of multiple lens groups or mutually complement aberration characteristics that change due to movement. Accordingly, the optical system according to the embodiment can minimize or prevent changes in chromatic aberration and aberration characteristics that occur when the magnification changes.

The optical system and camera module according to the embodiment can control the effective focal length (EFL) by moving only some of the multiple lens groups and can minimize the movement distance of the moving lens group. Accordingly, the optical system can reduce the movement distance of the moving lens group according to the change in the operation mode and minimize the power consumption required when the lens group moves. The optical system may have at least one lens included in the fixed group and the moving group have a non-circular shape. Accordingly, the optical system can reduce the height of the optical system while maintaining the optical performance, and secure a space in which the lens groups arranged between the plurality of lens groups are structurally arranged.

The optical system and the camera module according to the embodiment can adjust the magnification to enlarge or reduce the object by moving a lens group other than the first lens group adjacent to the subject among the plurality of lens groups. Accordingly, the optical system may have a constant TTL value even when the lens group is moved according to the magnification change so as to have multiple focal lengths, and may be applied to a camera module for linear zoom. Therefore, the optical system and the camera module including the same may be provided with a slimmer structure.

### DESCRIPTION OF DRAWINGS

FIG. 1 is a configuration diagram of an optical system and a camera module having the same according to an embodiment of the invention.

FIG. 2 is an example of a change in the first mode of the optical system of FIG. 1.

FIG. 3 is an example of a change in the third mode in the optical system of FIGS. 1 and 2.

FIG. 4 is a configuration having a reflective mirror in the optical system of FIG. 1.

FIG. 5 is a table of lens data of an optical system according to an embodiment of the invention.

FIG. 6 is a table showing aspherical coefficients of lenses of an optical system according to an embodiment of the invention.

FIG. 7 is a graph showing relative illumination according to positions of wide, middle, and tele modes according to an embodiment of the invention.

FIG. 8 is a graph of diffraction MTF in an optical system of a first mode (Wide Mode) according to an embodiment of the invention.

FIG. 9 is a graph of diffraction MTF in an optical system of a second mode (Middle Mode) according to an embodiment of the invention.

FIG. 10 is a graph of diffraction MTF in an optical system of a third mode (Tele Mode) according to an embodiment of the invention.

FIG. 11 is a graph showing aberration characteristics in an optical system of a first mode according to an embodiment of the invention.

FIG. 12 is a graph showing aberration characteristics in an optical system of a second mode according to an embodiment of the invention.

FIG. 13 is a graph showing aberration characteristics in an optical system of a third mode according to an embodiment of the invention.

FIG. 14 is a drawing showing a camera module according to an embodiment of the invention applied to a mobile terminal.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology.

The terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element. Several embodiments described below may be combined with each other, unless it is specifically stated that they cannot be combined with each other. In addition, the description of other embodiments may be applied to parts omitted from the description of any one of several embodiments unless otherwise specified.

In the description of the invention, a convex surface of the lens may mean that the lens surface in a region corresponding to the optical axis has a convex shape based on the optical axis, and a concave surface of the lens may mean that the lens surface in a region corresponding to the optical axis has a concave shape. In addition, the “object-side surface” may mean a surface of the lens facing the object side based on the optical axis, and the “sensor-side surface” may mean a surface of the lens facing the imaging surface (image sensor) based on the optical axis. In addition, a center thickness of the lens may mean the thickness of the lens in the optical axis direction. In addition, a vertical direction may mean a direction perpendicular to the optical axis, and the end of the lens or lens surface may mean the end of the effective region of the lens through which incident light passes. In addition, the size of the effective diameter of the lens surface may have a measurement error of up to ±0.4 mm depending on the measurement method, etc.

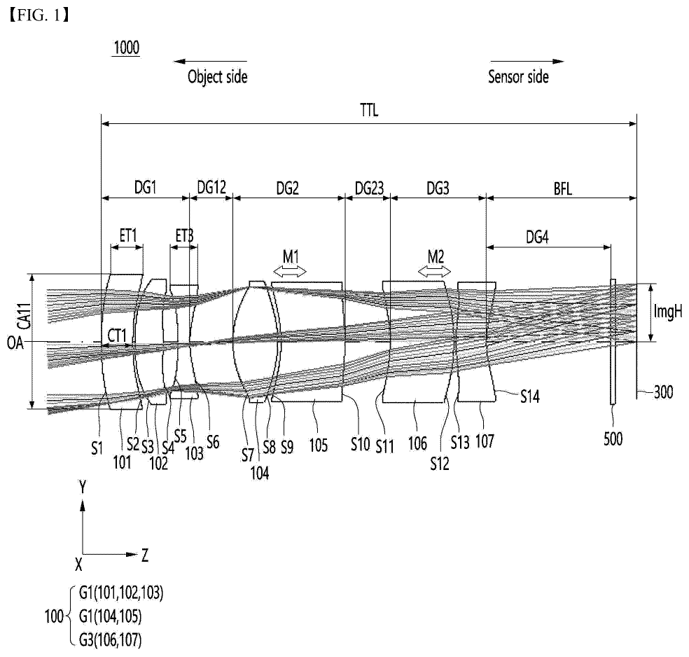

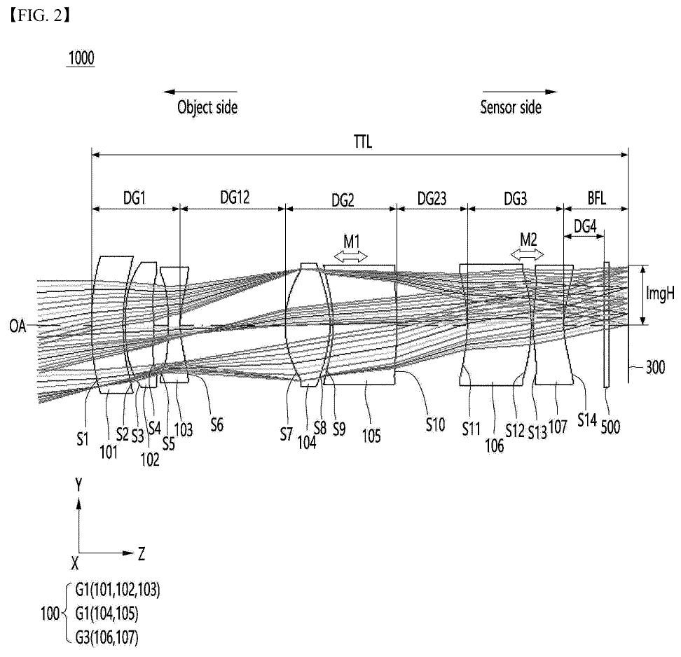

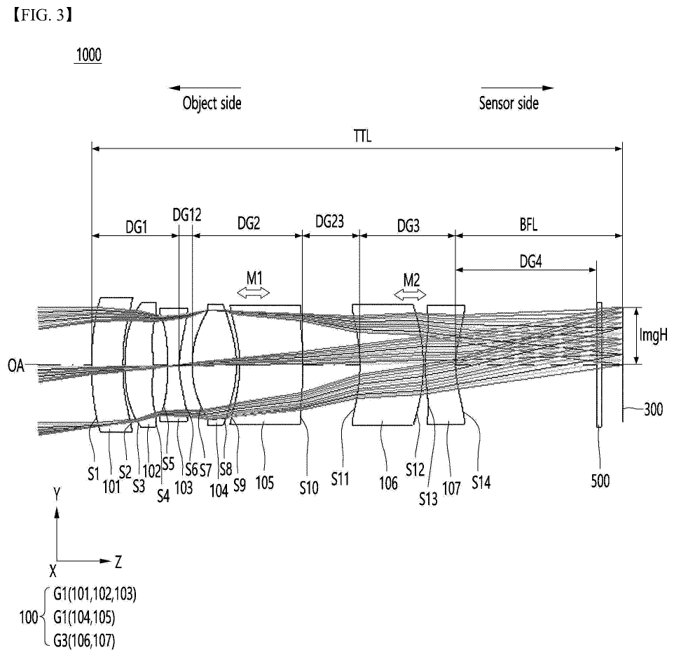

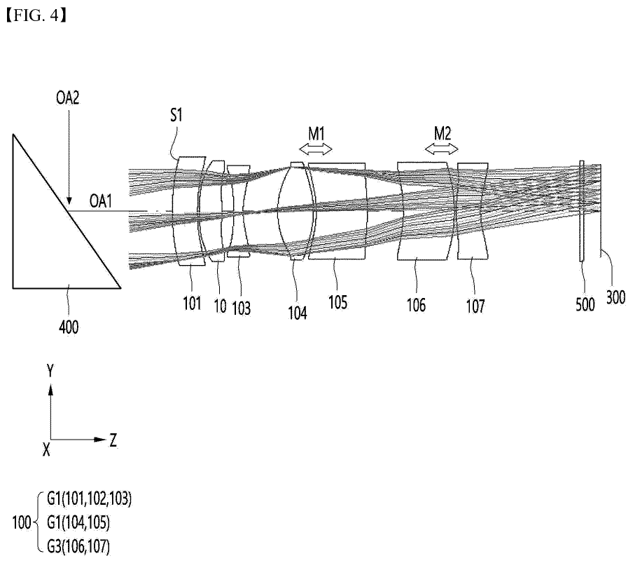

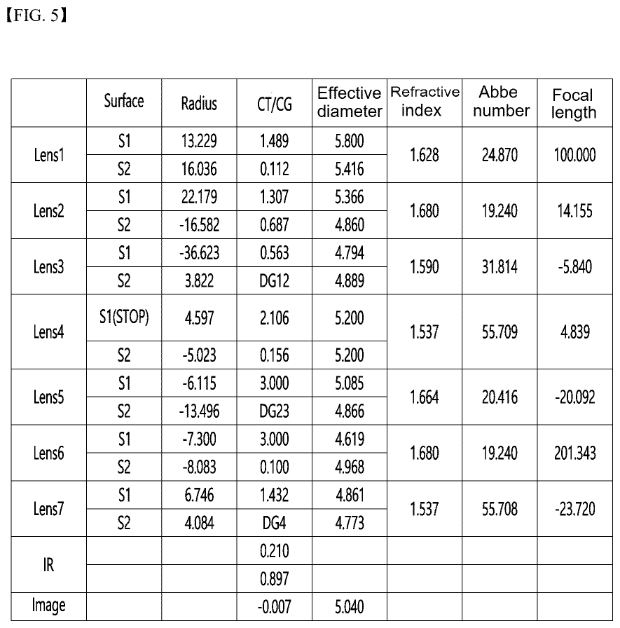

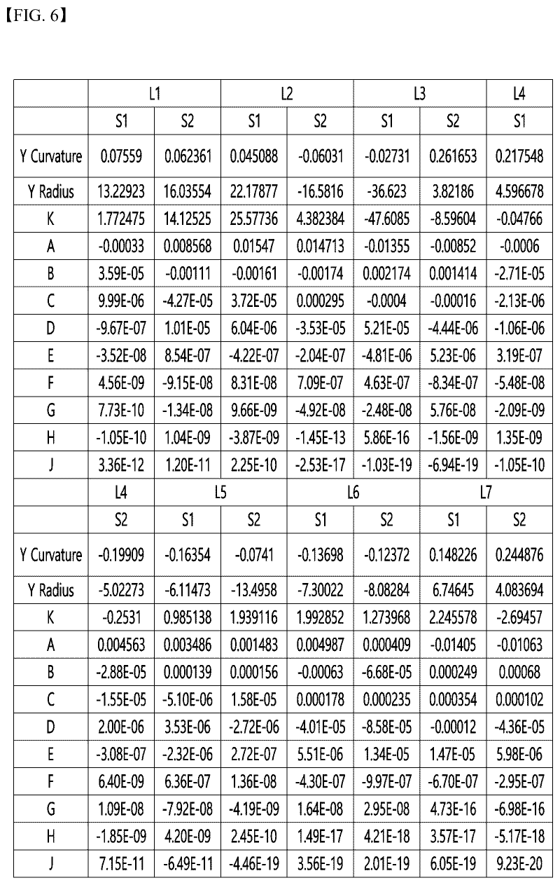

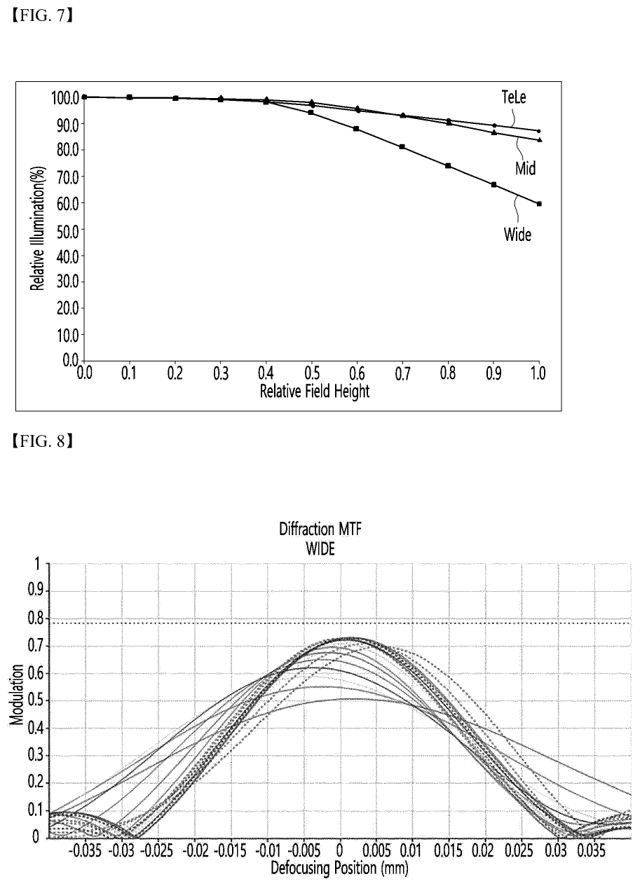

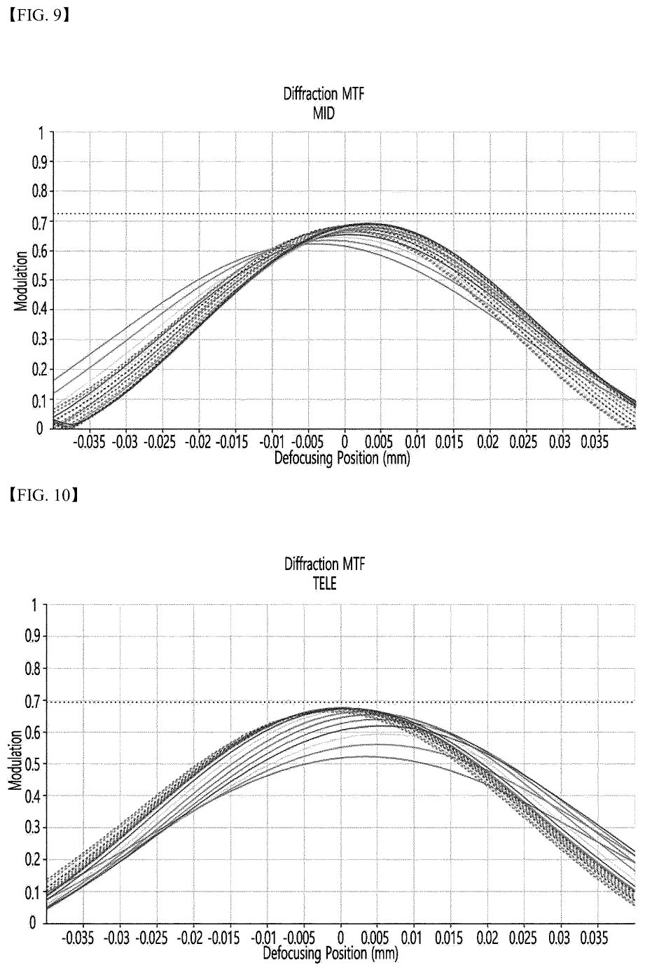

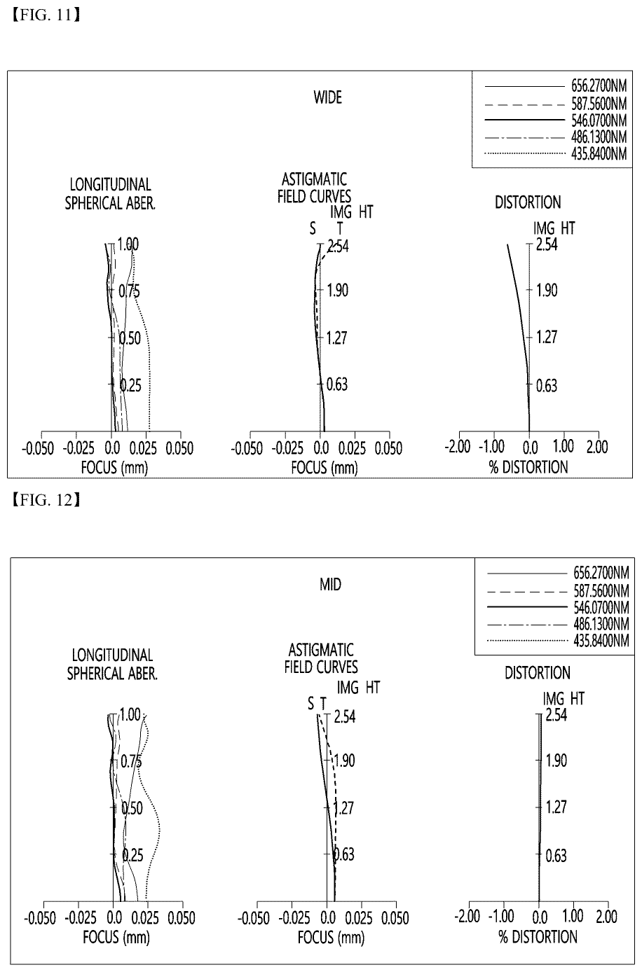

FIG. 1 is a configuration diagram of a first mode of a camera module or optical system according to an embodiment of the invention, FIG. 2 is an example of a change from the first mode of the optical system of FIG. 1 to the second mode, FIG. 3 is an example of a change from the optical system of FIGS. 1 and 2 to the third mode, FIG. 4 is a configuration having a reflective mirror in the optical system of FIG. 1, FIG. 5 is a table of lens data of an optical system according to an embodiment of the invention, FIG. 6 is a table showing aspherical coefficients of lenses of an optical system according to an embodiment of the invention, FIG. 7 is a graph showing relative illuminance according to positions of Wide, Middle, and Tele modes in a camera module according to an embodiment of the invention, FIG. 8 is a graph of diffraction MTF in an optical system of a first mode (Wide Mode) according to an embodiment of the invention, FIG. 9 is a graph of diffraction MTF in an optical system of a second mode (Middle mode) according to an embodiment of the invention, FIG. 10 is a graph of diffraction MTF in an optical system of a third mode (Tele mode) according to an embodiment of the invention, FIG. 11 is a graph showing the aberration characteristics in the optical system of the first mode according to an embodiment of the invention, FIG. 12 is a graph showing the aberration characteristics in the optical system of the second mode according to an embodiment of the invention, and FIG. 13 is a graph showing the aberration characteristics in the optical system of the third mode according to an embodiment of the invention.

Referring to FIGS. 1 to 6, the optical system 1000 according to the embodiment may include a plurality of lens groups G1, G2, and G3. In detail, the plurality of lens groups G1, G2, and G3 may have at least two lens groups movable in the direction of the optical axis OA and at least one lens group fixed in position. The plurality of lens groups G1, G2, and G3 may include a lens group fixed on the object side and a lens group movable on the sensor side. The plurality of movable lens groups may include an object-side lens group and a sensor-side lens group.

The lens group fixed on the object side may be defined as a first lens group G1, the object-side moving lens group may be defined as a second lens group G2, and the sensor-side moving lens group may be defined as a third lens group G3. The second lens group G2 may be disposed between the first lens group G1 and the third lens group G3. The first lens group G1 refracts incident light toward the second lens group G2, the second lens group G2 moves along the optical axis OA and changes the zoom magnification (focal length), and the third lens group G3 moves along the optical axis OA and can adjust the focus position on the image surface of the image sensor 300.

The optical system 1000 may include a first lens group G1, a second lens group G2, and a third lens group G3 sequentially arranged along an optical axis OA from an object toward a sensor. The optical system 1000 may include an image sensor 300 on the sensor side of the third lens group G3. The first lens group G1 may include a lens closest to the object side, and the third lens group G3 may include a lens closest to the sensor side. Each of the first to third lens groups G1, G2, and G3 may have positive (+) or negative (−) refractive power. For example, a lens group having positive refractive power may be smaller than a lens group having negative refractive power.

The first lens group G1 may have a refractive power of a sign opposite to the refractive power of the second lens group G2. For example, the first lens group G1 may have negative (−) refractive power, and the second lens group G2 may have positive (+) refractive power. The second lens group G2 may have a refractive power of a sign opposite to the sign of the refractive power of the third lens group G3. For example, the second lens group G2 may have positive (+) refractive power, and the third lens group G3 may have negative (−) refractive power.

The absolute value of the focal length of the third lens group G3 may be greater than the absolute value of the focal lengths of the first and second lens groups G1 and G2. For example, the absolute value of the focal length of the first lens group G1 may be 1.5 times or more than the focal length of the second lens group G2. Accordingly, the first lens group G1 may disperse incident light. The focal length of the second lens group G2 may be smaller than the absolute value of the focal length of the third lens group G3. The absolute value of the focal length of the third lens group G3 may be larger than the absolute value of the focal length of the first lens group G1. The power of the first and third lens groups G1 and G3 may have negative power, and the power of the second lens G2 may have positive power. The power is the reciprocal of the focal length value.

The number of lenses of the first lens group G1 may be larger than the number of lenses of the second lens group G2. The number of lenses of the second lens group G2 may be equal to or smaller than the number of lenses of the third lens group G3. For example, the number of lenses of the second and third lens groups G2 and G3 may be the same. The number of lenses in the first lens group G1 may be larger than the number of lenses in the second and third lens groups G2 and G3. The number of lenses of the first lens group G1 may include at least three lenses for adjusting the incident light amount, refractive power, and chromatic aberration. The third lens group G3 may include at least two lenses. The number of lenses of the first to third lens groups G1, G2, and G3 may be two or more. As another example, the optical system may further include at least one lens whose position is fixed between the third lens group G3 and the image sensor 300. Accordingly, the optical system 1000 may include six or more lenses and nine or fewer lenses.

Since the first and second lens groups G1 and G2 have refractive powers of opposite signs (+, −), aberrations may be corrected, and since the second and third lens groups G2 and G3 have refractive powers of opposite signs (+, −), aberrations may be corrected. The absolute value of the focal length of each of the first to third lens groups G1, G2, and G3 may decrease in the order of the third lens group G3, the first lens group G1, and the second lens group G2. The first lens group G1 is fixed in position, the second lens group G2 and the third lens group G3 move (M1, M2) in the direction of the optical axis OA, and the optical system 1000 may provide various magnifications by the movement of at least two lens groups. Hereinafter, the first to third lens groups G1, G2, and G3 will be described in more detail. The first lens group G1 may include at least two lenses having refractive powers of opposite signs, and at least two lenses may have refractive powers of the same sign. For example, the first lens group G1 may include three lenses. The first lens group G1 may have a greater number of lenses having positive refractive power than lenses having negative refractive power.

The first lens group G1 may include a plurality of lenses, and the plurality of lenses may have a set interval on the optical axis OA. In detail, the center distance between the plurality of lenses 101, 102, and 103 included in the first lens group G1 may be a fixed interval according to the operation mode described below. For example, the center distance between adjacent lenses 101, 102, and 103 in the first lens group G1 may not change depending on the operation mode and may have a constant interval. Hereinafter, the center distance between the lenses may mean the optical axis distance between adjacent lenses.

The second lens group G2 may include a plurality of lenses, and may include lenses 104 and 105 having refractive powers of opposite signs. The plurality of lenses 104 and 105 included in the second lens group G2 may have a set interval. In detail, the center distance between adjacent lenses 104 and 105 within the second lens group G2 may be a fixed interval according to the operation mode described later.

The third lens group G3 may include a plurality of lenses, and may include lenses 106 and 107 having refractive powers of opposite signs. The plurality of lenses 106 and 107 included in the third lens group G3 may have a set interval. In detail, the center distance between the plurality of lenses 106 and 107 included in the third lens group G3 may be constant without changing even when the operation mode described later changes. For example, the center distances between adjacent lenses 106 and 107 may be constant without changing depending on the operation mode. The last lens included in the third lens group G3 has a set interval with the image sensor 300 or/and the optical filter 500, and the interval may vary depending on the operation mode.

The optical system 1000 may include first to seventh lenses. The first lens group G1 may include the first to third lenses 101, 102, and 103, and the second lens group G2 may include the fourth and fifth lenses 104 and 105. In addition, the third lens group G3 may include the sixth and seventh lenses 106 and 107. The first to seventh lenses and the image sensor 300 may be sequentially arranged along the optical axis OA of the optical system 1000.

At least one lens in the first lens group G1 may have an effective length in the first direction X and an effective length in the second direction Y orthogonal to the optical axis OA that are different from each other. The lenses in the first lens group G1 having different effective lengths in the first and second directions X and Y may be non-circular lenses, and for example, the effective length in the second direction Y may be shorter than the effective length in the first direction X. One or two or more of the first to third lenses 101, 102, and 103 may have an effective length in the second direction Y of the object-side surface that is shorter than the effective length in the first direction X. At least one of the lenses in the second lens group G2 may have an effective length in the first direction X orthogonal to the optical axis OA and an effective length in the second direction Y that are different from each other. The lenses of the second lens group G2 having different effective lengths in the first and second directions X and Y may be non-circular lenses, for example, the effective length in the second direction Y may be smaller than the effective length in the first direction X. One or both of the fourth and fifth lenses 104 and 105 may have an effective length in the second direction Y of the object-side surface smaller than the effective length in the first direction X.

At least one of the lenses in the third lens group G3 may have different lengths in the first direction X and the second direction Y perpendicular to the optical axis OA. The lenses of the first lens group G1 having different effective lengths in the first and second directions X and Y may be non-circular lenses, for example, the effective length in the second direction Y may be smaller than the effective length in the first direction X. In detail, among the lenses in the lens portion 100, the first lens 101 having the largest effective length may have an effective length in the first direction X that is longer than an effective length in the second direction Y. The second lens 102 may have an effective length in the first direction X that is longer than an effective length in the second direction Y. The fourth lens 104 may have an effective length in the first direction X that is longer than an effective length in the second direction Y. The effective lengths of the lenses of the first lens group G1 may gradually decrease from the object side toward the sensor side. The effective lengths of the lenses of the second lens group G2 may gradually decrease from the object side toward the sensor side. The effective lengths of the lenses of the third lens group G3 may increase from the object side toward the sensor side. Here, the effective length of each lens is an average of the effective lengths of the object side surface and the sensor side surface of each lens.

The optical system 1000 according to the embodiment can have improved assembly properties by non-circular lens(es) and have a mechanically stable form. In addition, the optical system 1000 can significantly reduce the moving distance DG12, DG23, and DG4 of the moving lens group G2 and G3 and provide various magnifications. In addition, since the lenses having a large effective length in the second direction Y are provided in a shape on which both sides in the second direction Y are cut, the height or thickness of the optical system 1000 and the camera module in the second direction Y may be reduced. Accordingly, the increase in thickness of the device having the slim optical system 1000 and the camera module may be suppressed.

Each of the lenses in the lens portion 100 may include an effective region and an ineffective region. The effective region is a region of an effective diameter and may be a region through which light incident on each of the first to seventh lenses 101-107 passes. The effective region may be a region where the incident light is refracted to implement optical characteristics. The ineffective region may be disposed around the effective region. The ineffective region may be a region where the light is not incident. In other words, the ineffective region may be a region unrelated to the optical characteristics. In addition, the ineffective region may be a region fixed to a barrel (not shown) that accommodates the lens. The image sensor 300 may detect light. The image sensor 300 may detect light that has sequentially passed through the lens portion 100, for example, the first to seventh lenses 101-107. The image sensor 300 may include a CCD (Charge Coupled Device) or a CMOS (Complementary Metal Oxide Semiconductor).

The optical system 1000 may further include an optical filter 500. The optical filter 500 may be disposed between the lens portion 100 and the image sensor 300. The optical filter 500 may be disposed between the image sensor 300 and the third lens group G3. For example, the optical filter 500 may be disposed between the last lens 107 and the image sensor 300. The optical filter 500 may include at least one of an infrared filter and a cover glass. The optical filter 500 may pass light of a set wavelength band and filter light of a different wavelength band. When the optical filter 500 includes an infrared filter, it may block radiant heat emitted from external light from being transmitted to the image sensor 300. The optical filter 500 may transmit visible light and reflect infrared light.

The optical system 1000 may include an aperture stop (not shown). The aperture stop can control the amount of light incident on the optical system 1000. The aperture stop may be disposed on the periphery of the object-side surface of the fourth lens 104. The aperture stop may be disposed between two lenses selected from the first to seventh lenses 101-107. For example, the aperture stop may be disposed on the periphery between the third lens 103 and the fourth lens 104. The aperture stop may be disposed on the periphery of the sensor-side surface of the third lens 103 or the periphery of the object-side surface of the fourth lens 104. Alternatively, at least one lens among the first to seventh lenses 101-107 can function as an aperture stop. For example, the outer portion of the object-side surface or the sensor-side surface of one lens selected from the first to seventh lenses 101-107 can function as an aperture stop for controlling the amount of light. For example, at least one of the sensor-side surface of the third lens 103 and the object-side surface of the fourth lens 104 may function as an aperture stop.

The object-side surface and the sensor-side surface of the first to seventh lenses 101-107 may be aspherical. The first to seventh lenses 101-107 may be made of a plastic material. Alternatively, at least one of the first to third lenses 101, 102, and 103 may be made of a glass material.

As shown in FIG. 4, the optical system 1000 may further include an optical path changing member 400. The optical path changing member 400 may reflect light incident from the outside to change the path of the light from the second path OA2 to the first path OA1. The optical path changing member 400 may include a reflector or a prism. For example, the optical path changing member 400 may include a right-angled prism. When the optical path changing member 400 includes a right-angled prism, the optical path changing member 400 may reflect the second path OA2 of the incident light at an angle of 90 degrees to change the first path OA1 of the light. The first path OA1 may be in the direction of the optical axis of the optical system. The optical path changing member 400 may be disposed closer to the object side than the plurality of lenses. That is, when the optical system 1000 includes the optical path changing member 400, the optical path changing member 300, the first lens 101 to the seventh lens 107, the filter 500, and the image sensor 300 may be arranged in this order from the object side toward the sensor.

The optical path changing member 400 can change the path of light incident from the outside in a set direction. For example, the optical path changing member 400 can change the second path OA2 of light incident on the optical path changing member 400 in the second direction Y to the first path OA1 in the third direction Z, which is the arrangement direction of the plurality of lenses. When the optical system 1000 includes the optical path changing member 400, the optical system may be applied to a folded camera, thereby reducing the thickness of the camera. In detail, when the optical system 1000 includes the optical path changing member 400, light incident in a direction Y perpendicular to the surface of the device to which the optical system 1000 is applied may be changed into a direction Z parallel to the surface of the device. Accordingly, the optical system 1000 including a plurality of lenses can have a thinner thickness within the device, so that the height of the device may be reduced.

When the optical system 1000 does not include the optical path changing member, the plurality of lenses may be arranged to extend in a direction Y perpendicular to the surface of the device. Accordingly, the optical system 1000 including the plurality of lenses has a high height in a direction perpendicular to the surface of the device (first direction), so that it may be difficult to form the optical system 1000 and the device including it thin. However, when the optical system 1000 includes the optical path changing member 400, the plurality of lenses may be disposed to extend in a direction Z parallel to the surface of the device. That is, the optical system 1000 is arranged so that the optical axis OA is parallel to the surface of the device and may be applied to a folded camera. Accordingly, the optical system 1000 including the lens portion 100 may have a low height in a direction perpendicular to the surface of the device. Accordingly, the camera including the optical system 1000 may have a thin thickness within the device, and the thickness of the device may also be reduced. As another example, the optical path changing member may be disposed between two lenses of the lens portion 100, or may be further arranged between the last lens adjacent to the image sensor 300 and the image sensor 300. As another example, the optical path changing member may be provided in multiple pieces. In detail, a plurality of optical path changing members may be disposed between the object and the image sensor 300. For example, the plurality of optical path changing members may include a first optical path changing member arranged closer to the object side than the plurality of lenses, and a second optical path changing member arranged between the last lens and the image sensor 300. Accordingly, the optical system 1000 may have various shapes and heights depending on the camera to which it is applied, and may have improved optical performance.

Referring to FIGS. 1 to 3, the first lens 101 may be disposed closest to the object among the plurality of lenses, and the seventh lens 107 may be disposed closest to the image sensor 300. For convenience of explanation, a center thickness 101-107 is CT1 to CT7, an edge thickness is ET1 to ET7, an Abbe number is Vd1 to Vd7, a refractive index is Nd1 to Nd7, an average of the effective lengths is CA1 to CA7, and a focal length may be defined as F1 to F7 of each of the first to seventh lenses.

The first lens 101 may have positive (+) refractive power on the optical axis OA. The first lens 101 may include a plastic or glass material, and may be, for example, a plastic material. The first lens 101 may include a first surface S1 on the object side and a second surface S2 on the sensor side. The first surface S1 may have a convex shape on the optical axis OA, and the second surface S2 may have a concave shape on the optical axis OA. That is, the first lens 101 may have a meniscus shape convex toward the object side on the optical axis OA. Alternatively, the first lens 101 may have a shape in which both sides are convex on the optical axis. Alternatively, the first lens 101 may have a meniscus shape convex toward the sensor side. At least one of the first surface S1 and the second surface S2 may be aspherical. For example, both the first surface S1 and the second surface S2 may be aspherical. The aspherical coefficients of the first and second surfaces S1 and S2 may be expressed as L1S1 and L1S2 in FIG. 6.

The first lens 101 may have the largest effective length among the lenses, that is, the maximum effective length. That is, the effective length of the first surface S1 of the first lens 101 in the second direction Y may be the largest among the lenses. The average of the effective lengths of the first and second surfaces S1 and S2 of the first lens 101 in the second direction Y may be greater than the average of the effective lengths of the object-side surfaces and the sensor-side surfaces of the second to seventh lenses 102 to 107. Accordingly, the first lens 101 may improve optical aberrations or control incident light. The first surface S1 and the second surface S2 may be provided without a critical point from the optical axis to the end of the effective region.

The second lens 102 may have positive (+) or negative (−) refractive power on the optical axis OA, for example, may have positive refractive power. The second lens 102 may include a plastic or glass material, for example, may be a plastic material. The second lens 102 may include a third surface S3 defined as an object-side surface and a fourth surface S4 defined as a sensor-side surface. The third surface S3 may have a convex shape on the optical axis OA, and the fourth surface S4 may have a convex shape on the optical axis OA. The second lens 102 may have a shape in which both sides are convex on the optical axis OA. Alternatively, the third surface S3 may have a convex shape on the optical axis OA, and the fourth surface S4 may have a concave shape. Alternatively, the third surface S3 may have a concave shape on the optical axis OA, and the fourth surface S4 may have a convex shape on the optical axis OA. In contrast, the third surface S3 may have a concave shape on the optical axis OA, and the fourth surface S4 may have a convex shape on the optical axis OA. At least one surface of the third surface S3 and the fourth surface S4 of the second lens 102 may be aspherical. For example, both the third surface S3 and the fourth surface S4 may be aspherical. The aspherical coefficients of the third and fourth surfaces S3 and S4 may be represented by L2S1 and L2S2 of FIG. 6. The third surface S3 and the fourth surface S4 may be provided without a critical point from the optical axis to the end of the effective region, or at least one of the third surface S3 and the fourth surface S4 may have a critical point.

The third lens 103 may have positive (+) or negative (−) refractive power on the optical axis OA, and may have, for example, negative (−) refractive power. The third lens 103 may include a plastic or glass material, and may be, for example, a plastic material. The third lens 103 may include a fifth surface S5 defined as an object-side surface and a sixth surface S6 defined as a sensor-side surface. The fifth surface S5 may have a concave shape on the optical axis OA, and the sixth surface S6 may have a concave shape on the optical axis OA. Alternatively, the fifth surface S5 may have a convex shape on the optical axis OA, and the sixth surface S6 may have a concave shape. Alternatively, the fifth surface S5 may have a concave shape on the optical axis OA, and the sixth surface S6 may have a convex shape. Alternatively, the fifth and sixth surfaces S5 and S6 may have convex shapes on the optical axis OA. At least one of the fifth surface S5 and the sixth surface S6 of the third lens 103 may be aspherical. For example, both the fifth surface S5 and the sixth surface S6 may be aspherical. Aspherical coefficients of the fifth and sixth surfaces S5 and S6 may be represented by L3S1 and L3S2 of FIG. 6. The fifth surface S5 and the sixth surface S6 may be provided without critical points from the optical axis to the ends of the effective regions. As another example, at least one of the fifth side S5 and the sixth side S6 may have a critical point from the optical axis to the end of the effective region.

The second lens 102 and the third lens 103 may compensate for chromatic aberration occurring in the first lens 101. The refractive index of the second lens 102 may be greater than 1.6. The second lens 102 may be one of the lenses having the highest refractive index. The radius of curvature of the sixth surface S6 of the third lens 103 may be the smallest among the radii of curvature of the object-side surface and the sensor-side surface of each lens 101, 102, and 103 of the first lens group G1. The absolute value of the radius of curvature of the sixth surface S6 of the third lens 103 may be the largest among the lenses. The absolute value of the radius of curvature of the fifth surface S5 of the third lens 103 may be the largest among the radii of curvature of the object-side surface and the sensor-side surface of each lens 101, 102, and 103 of the first lens group G1. Accordingly, since the first lens group G1 controls the dispersion of light provided to the second lens group G2, the lens size of the second lens group G2 may be reduced. The variable size of the center distance DG12 between the first and second lens groups G1 and G2 may be set according to the operating mode by the radius of curvature of the sixth surface S6 of the third lens 103.

The fourth lens 104 may have positive (+) refractive power at the optical axis OA. The fourth lens 104 may include a plastic or glass material, and may be, for example, a plastic material and have a refractive index of less than 1.6. The fourth lens 104 may include a seventh surface S7 defined as an object-side surface and an eighth surface S8 defined as a sensor-side surface. The seventh surface S7 may have a convex shape on the optical axis OA, and the eighth surface S8 may have a convex shape on the optical axis OA. That is, the fourth lens 104 may have a shape in which both sides are convex on the optical axis OA. Alternatively, the seventh surface S7 may be convex on the optical axis OA, and the eighth surface S8 may be concave on the optical axis OA. That is, the fourth lens 104 may have a meniscus shape convex toward the object on the optical axis OA. At least one of the seventh surface S7 and the eighth surface S8 of the fourth lens 104 may be aspherical. For example, both the seventh surface S7 and the eighth surface S8 may be aspherical. The aspherical coefficients of the seventh and eighth surfaces S7 and S8 may be represented by L4S1 and L4S2 in FIG. 6. The seventh surface S7 and the eighth surface S8 may be provided without a critical point from the optical axis to the end of the effective region.

The fifth lens 105 may have positive (+) or negative (−) refractive power on the optical axis OA. The fifth lens 105 may have negative refractive power opposite to the sign of the refractive power of the fourth lens 104 on the optical axis OA. The fifth lens 105 may include a plastic or glass material, and may be, for example, a plastic material. The fifth lens 105 may include a ninth surface S9 defined as an object-side surface and a tenth surface S10 defined as a sensor-side surface. The ninth surface S9 may have a concave shape on the optical axis OA, and the tenth surface S10 may have a convex shape on the optical axis OA. That is, the fifth lens 105 may have a meniscus shape convex toward the sensor on the optical axis OA. At least one surface of the ninth surface S9 and the tenth surface S10 may be aspherical. For example, both the ninth surface S9 and the tenth surface S10 may be aspherical. Aspherical coefficients of the ninth and tenth surfaces S9 and S10 may be represented by L5S1 and L5S2 of FIG. 6. The ninth surface S9 and the tenth surface S10 of the fifth lens 105 may be provided without a critical point from the optical axis to the end of the effective region. As another example, the ninth surface S9 of the fifth lens 105 may have a convex shape on the optical axis OA, and the tenth surface S10 may have a convex shape on the optical axis OA. That is, the fifth lens 105 may have a shape in which both sides are convex on the optical axis OA. Differently, the ninth surface S9 may have a concave shape on the optical axis OA, and the tenth surface S10 may have a concave shape on the optical axis OA. Differently, the ninth surface S9 may have a convex shape on the optical axis OA, and the tenth surface S10 may have a concave shape on the optical axis OA.

The fourth lens 104 has a biconvex shape, and the center thickness CT4 of the fourth lens 104 may be thicker than the edge thickness ET4, for example, may be at least twice the edge thickness ET4. Accordingly, the distance between the fourth lens 104 and the fifth lens 105 may be reduced. The fourth lens 104 may be one of the lenses having the largest Abbe number among the lenses or may have an Abbe number of 45 or more. The difference in Abbe number between the fourth lens 104 and the fifth lens 105 may be greater than 20 or greater than 25, and may be at most 55 or less. Accordingly, the second lens group G2 may minimize chromatic aberration change caused by a position that changes according to a change in the operation mode.

The sixth lens 106 may be the n-lth lens. The sixth lens 106 may have positive (+) or negative (−) refractive power on the optical axis OA, and may have, for example, positive refractive power. The sixth lens 106 may include a plastic or glass material, and may be, for example, a plastic material. The sixth lens 106 may include an eleventh surface S11 defined as an object-side surface and a twelfth surface S12 defined as a sensor-side surface. The eleventh surface S11 may have a concave shape on the optical axis OA, and the twelfth surface S12 may have a convex shape on the optical axis OA. That is, the sixth lens 106 may have a meniscus shape that is convex toward the sensor side on the optical axis OA. In this way, the eleventh surface S11 may have a convex shape on the optical axis OA, and the twelfth surface S12 may have a convex shape on the optical axis OA. That is, the sixth lens 106 may have a convex shape on both sides in the optical axis OA. In this way, the eleventh surface S11 may have a concave shape on the optical axis OA, and the twelfth surface S12 may have a concave shape on the optical axis OA. In this way, the eleventh surface S11 may have a convex shape on the optical axis OA, and the twelfth surface S12 may have a concave shape on the optical axis OA.

At least one surface among the eleventh surface S11 and the twelfth surface S12 of the sixth lens 106 may be aspherical. For example, both the eleventh surface S11 and the twelfth surface S12 may be aspherical. The aspherical coefficients of the eleventh and twelfth surfaces (S11, S12) may be represented by L6S1 and L6S2 in FIG. 6. The eleventh surface S11 and the twelfth surface S12 may be provided without a critical point from the optical axis to the end of the effective region. The sixth lens 106 may be one of the lenses having the thickest center thickness CT6 among the center thicknesses of the lenses. That is, at least one or both of the center thicknesses CT5 and CT6 of the fifth and sixth lenses 105 and 106 may have the thickest thickness among the lenses. Accordingly, since the center thickness CT6 of the sixth lens 106 is provided thickly, the number of lenses of the third lens group G3 may be reduced.

The seventh lens 107 may be the n-th lens. The seventh lens 107 may have positive (+) or negative (−) refractive power on the optical axis OA, and may have negative refractive power. The refractive power of the seventh lens 107 has a sign opposite to the sign of the refractive power of the sixth lens 106, so as to improve chromatic aberration. The seventh lens 107 may include a plastic or glass material, and may be, for example, a plastic material. The seventh lens 107 may include a thirteen surface S13 defined as an object-side surface and a fourteen surface S14 defined as a sensor-side surface. The thirteen surface S13 may have a convex shape on the optical axis OA, and the fourteen surface S14 may have a concave shape on the optical axis OA. That is, the seventh lens 107 may have a meniscus shape that is convex toward the object on the optical axis OA. As another example, the thirteen surface S13 may have a convex shape on the optical axis OA, and the fourteen surface S14 may have a convex shape on the optical axis OA. Alternatively, the thirteen surface S13 may have a concave shape on the optical axis OA, and the fourteen surface S14 may have a convex shape on the optical axis OA. That is, the seventh lens 107 may have a meniscus shape that is convex toward the sensor on the optical axis OA. Alternatively, the thirteen surface S13 may have a concave shape on the optical axis OA, and the fourteen surface S14 may have a concave shape on the optical axis OA. That is, the seventh lens 107 may have a shape in which both sides are concave on the optical axis OA.

The fifth lens 105 and the sixth lens 106 have refractive powers of opposite signs, and the Abbe number difference may be set to 10 or less. Accordingly, the fifth and sixth lenses 105 and 106 may compensate for chromatic aberration. Accordingly, the third lens group G3 can minimize chromatic aberration changes caused by positions that change according to mode changes and perform an achromatic function.

At least one of the thirteen surface S13 and the fourteen surface S12 of the seventh lens 107 may be aspherical. For example, both the thirteen surface S13 and the fourteen surface S14 may be aspherical. The aspherical coefficients of the thirteen and fourteen surfaces S13 and S14 may be represented by L7S1 and L7S2 of FIG. 6. The thirteen surface S13 and the fourteen surface S14 may be provided without a critical point from the optical axis to the end of the effective region. As another example, at least one of the thirteen surface S13 and the fourteen surface S14 of the seventh lens 107 may have a critical point between the optical axis and the end of the effective region, and the critical point is a point where the tendency of the Sag value changes. That is, the critical point is a point where the Sag value increases and then decreases on the lens surface, or a point where the Sag value decreases and then increases. The Sag value is the optical axis distance between a straight line perpendicular to the center of each lens surface and the lens surface, and the Sag value has a positive value at a position located on the sensor side relative to the center of each lens surface, and has a negative value at a position located on the object side relative to the center of each lens surface. The sixth lens 106 and seventh lens 107 have refractive powers of opposite signs, and the Abbe number difference may be set to 20 or more, and can control chromatic aberration. Accordingly, the chromatic aberration change caused by the position changing according to the movement of the third lens group G3 may be minimized and the achromatic function may be performed.

The center thickness CT7 of the seventh lens 107 may be thinner than the edge thickness ET7. Accordingly, the difference between the center thickness and the edge thickness of the seventh lens 107 and the concave shape of the fourteen surface S14 may refract the incident light to the periphery of the image sensor 300. The third lens group G3 may be closest to the image sensor 300 among the plurality of lens groups G1, G2, and G3. The third lens group G3 may be moved in the optical axis direction, and the optical axis distance BFL between the seventh lens 107 and the image sensor 300 may vary depending on the operation mode. Here, the BFL is the optical axis distance from the center of the sensor-side surface of the seventh lens 107 to the image sensor 300.

The third lens group G3 may perform a role of controlling the chief ray angle (CRA). In detail, the CRA of the optical system 1000 according to the embodiment may be less than about 20 degrees, and the seventh lens 107 of the third lens group G3 may correct the chief ray angle of light incident on the image sensor 300 according to each operation mode.

The camera module according to the embodiment of the invention may include the optical system 1000 described above. The camera module may be configured such that two lens groups G2 and G3 on the sensor side among a plurality of lens groups G1, G2, and G3 included in the optical system 1000 may move in the direction of the optical axis OA. The camera module may include a driving member (not shown) connected to the optical system 1000. The driving members are arranged on the outer side of the second lens group G2 and the outer side of each of the third lens groups G3, and may move in the direction of the optical axis OA according to the operation mode. The operation mode may include a first mode that moves at a first magnification, as shown in FIG. 2, and a third mode that operates at a second magnification different from the first magnification, as shown in FIG. 3. In this case, the second magnification may be greater than the first magnification. In addition, the operation mode may include a second mode that has a magnification between the first and third modes, as shown in FIG. 1. Here, the first magnification may be the lowest magnification of the optical system 1000, and the second magnification may be the highest magnification of the optical system 1000. The first magnification may be about 1.5 magnification or more, for example, about 1.5 magnification to about 5 magnifications, the second magnification may be about 6 magnifications to about 11 magnifications, and the third magnification may be about 4 magnifications to about 6 magnifications between the first and second magnifications. The first mode may be a wide mode, the second mode may be a middle mode, and the third mode may be a tele mode.

The driving member may move (M1, M2) each of the second and third lens groups G2 and G3 or operate them in an initial mode according to one operation mode selected from the first to third modes. In detail, each of the plurality of driving members is connected to the second lens group G2 and the third lens group G3, and may move the second lens group G2 or the third lens group G3 depending on the operation mode. The initial mode may be any one of the first, second, and third modes, and may be, for example, the second mode or the middle mode. For example, in the first mode, each of the second lens group G2 and the third lens group G3 may be positioned at a position defined as a first position (Position 1). In the second mode, each of the second lens group G2 and the third lens group G3 may be positioned at a position defined as a second position (Position 2) closer to the object than the first position. In the third mode, each of the second lens group G2 and the third lens group G3 may be positioned at a third position (Position 3) closer to the sensor than the first position. The first position may be a region between the second and third positions.

The first position at which the second lens group G2 is positioned in the first mode may be a region between the second and third positions at which the second lens group G2 is positioned in the second and third modes. The first position at which the third lens group G3 is positioned in the first mode may be a region between the second and third positions at which the third lens group G3 is positioned in the second and third modes.

Depending on the operation mode, at least one of the second lens group G2 and the third lens group G3 may move (M1, M2) along the optical axis OA, and the first lens group G1 may be disposed at a fixed position. Depending on the operation mode, the second lens group G2 may move (M1) along the optical axis OA, and the first lens group G1 may be disposed at a fixed position. Depending on the operation mode, the third lens group G3 can move (M2) along the optical axis OA, and the first lens group G1 may be arranged at a fixed position. For example, the optical axis distance DG12 between the sensor-side surface of the third lens 103 and the object-side surface of the fourth lens 104 may be varied depending on the operation mode. The optical axis distance DG23 between the sensor-side surface of the fifth lens 105 and the object-side surface of the sixth lens 106 may be varied depending on the operation mode.

In each of the first position, the second position, and the third position according to the operation mode, the first to third lens groups G1, G2, and G3 may have a set gap from the adjacent lens groups. Accordingly, the optical system 1000 may have a constant TTL (Total track length) and a variable BFL depending on the operation mode, and may control the effective focal length and magnification of the optical system 1000 by controlling the positions of some lens groups. In addition, the optical axis distance DG4 between the third lens group G3 and the optical filter 500 may be variable depending on the operation mode.

The effective length CA1 of the first lens 101 is the largest among the lenses, and the effective diameter CA6 of the sixth lens 106 is the smallest among the lenses. The effective length CA1 of the first lens 101 may be 5 mm or more. The effective length CA6 of the sixth lens 106 may be less than 5 mm, for example, 3.8 mm or more. In the absolute value of the focal length, the focal length F6 of the first lens 106 may be the largest among the lenses, and the difference (absolute value) of the focal length between adjacent two lenses may be the largest between the fifth and sixth lenses 105 and 106, and the smallest between the third and fourth lenses 103 and 104. The aperture stop is disposed around the object-side surface of the fourth lens 104, and the focal length of the fourth lens 104 may be the smallest among the lenses. That is, the lens having the largest absolute value of the focal length may be disposed within the third lens group G3, and the lens having the smallest absolute value of the focal length may be disposed within the second lens group G2.

The center thickness CT1 of the first lens 101 may be the thickest within the first lens group G1. The absolute value of the radius of curvature of the first to fourth surfaces S1, S2, S3, and S4 of the first and second lenses 101 and 102 is set to 5 mm or more, so as not to significantly change the angle of refraction of the incident light, and to guide it to the fourth lens 104 of the second lens group G2 through the third lens 103. The sum of the center thicknesses CT3 and CT4 of the third and fourth lenses 103 and 104 may be greater than the sum of the center thicknesses CT1, CT2, and CT3 of the first, second, and third lenses 101, 102, and 103. The sum of the center thicknesses CT3 and CT4 of the third and fourth lenses 103 and 104 may be greater than the sum of the center thicknesses CT6 and CT7 of the sixth and seventh lenses 106 and 107. Accordingly, the second lens group G2 can guide the light incident through the first lens group G1 to the effective region of the third lens group G3. The sum of the center thicknesses CT6 and CT7 of the sixth and seventh lenses 106 and 107 may be greater than the sum of the center thicknesses of the first to third lenses 101, 102, and 103. Accordingly, the third lens group G3 may provide a small change in the passing light path.

The optical axis distance DG12 between the first and second lens groups G1 and G2 and the optical axis distance DG23 between the second and third lens groups G2 and G3 may be at least 0.2 mm and at most 8 mm, depending on the change in magnification of the operation modes. Specifically, the optical axis distance DG12 between the first and second lens groups G1 and G2 may be moved by 0.2 mm or more, for example, within a range of 0.2 mm to 8 mm, and the optical axis distance DG23 between the second and third lens groups G2 and G3 may be moved by 1 mm or more, for example, within a range of 1 mm to 4 mm. In addition, the center distance DG4 between the seventh lens 107 and the optical filter 500 may be moved by 1 mm or more, for example, within a range of 1 mm to 10 mm.

The relationship between DG12, DG23, and DG4 in the first, second, and third modes is as follows.

DG4<DG23<DG12 First mode:

DG12<DG23<DG4 Second mode:

DG12<DG23<DG4 Third mode:

Depending on the operation mode, the F number of the optical system 1000 provides a brightness of 2.0 or more, and the F number may be in the range of 2.2 to 3.8. The aperture stop may be located between the first lens group G1 and the second lens group G2.

The optical system 1000 according to the embodiment may satisfy at least one or two or more of the equations described below. Accordingly, the optical system 1000 according to the embodiment may effectively correct aberrations that change according to a change in the operation mode. In addition, the optical system 1000 according to the embodiment can effectively provide an autofocus (AF) function for a subject at various magnifications, and can have a slim and compact structure.

Hereinafter, the optical axis distance between two adjacent lenses may be defined as CG1 to CG7 from the distance between the first and second lenses to the distance between the seventh and eighth lenses. The effective lengths of the object-side surface and the sensor-side surface of the first lens 101 to the object-side surface and the sensor-side surface of the seventh lens 107 may be defined as CA11, CA12 to CA71, and CA72. The units of the thickness, distance, and effective diameter values are mm. In addition, the effective length may be defined as the long axis effective length or the maximum diameter when the shape of the lens surface includes a circular or non-circular shape, and the lens has a partially circular shape.

nL_G1>nL_G3 (nL is an integer greater than or equal to 2) [Equation 1]

In equation 1, nL_G2 means the number of lenses included in the second lens group G2. Here, nL_G1>nL_G2, nL_G1>nL_G3 may be satisfied.

0.7<CA41/CA11<1.5 [Equation 2]

In equation 2, CA41 is the effective length of the seventh surface S7 of the fourth lens 104, and CA11 is the effective length of the first surface S1 of the first lens 101 or the effective length in the long axis direction. When equation 2 is satisfied, a high EPD (Entrance pupil diameter) compared to the optical system may be provided. Preferably, 0.7<CA41/CA11<1 may be satisfied.

1<CT1/CT3<4 [Equation 3]

If equation 3 satisfies the center thickness of the first and third lenses 101 and 103, the aberration characteristic of the optical system 1000 may be improved. Preferably, 2<CT1/CT3<3.5 may be satisfied.

0<CT1/CT4<1 [Equation 4]

If equation 4 satisfies the center thickness of the first and fourth lenses 101 and 104, the optical system 1000 can improve the aberration characteristic. Preferably, 0.3<CT1/CT4<0.85 may be satisfied. The center thickness CT4 of the fourth lens 104 is the thickest among the lenses and has a convex shape on both sides, so that the fourth lens 104 can improve the light incident efficiency of the first lens group G1 and refract the light into the effective region of the sixth lens 106 having the smallest effective length.

2<CT4/CT3<5 [Equation 4-1]

In the case where the center thicknesses of the third and fourth lenses 103 and 104 in Equation 4-1 are satisfied, the optical system 1000 can improve the aberration characteristics. In addition, by providing a thick center thickness CT4 of the fourth lens 104 that is convex on both sides, the fourth lens 104 can refract the incident light into the entire area of the fifth lens 105. Preferably, 3<CT4/CT3<4 may be satisfied.

1<ET3/CT3<4 [Equation 5]

In equation 4, ET3 means the thickness (mm) in the direction of the optical axis OA at the edge, which is the end of the effective region of the third lens 103. When the optical system 1000 according to the embodiment satisfies equation 5, the optical system 1000 can improve the distortion characteristics of light passing through the first lens group G1. Preferably, 1.5<ET3/CT3<2.6 may be satisfied.

2<CT4/ET4<3.5 [Equation 5-1]

In equation 5-1, the center thickness CT4 of the fourth lens 104 is set to be twice more than the edge thickness ET4, thereby improving the aberration of the optical system 1000. Preferably, 2.2<CT4/ET4<3 may be satisfied.

Here, if the center thickness of the i-th lens is CTi and the edge thickness of the i-th lens is ETi, the ratio of CTi/ETi may be the largest when i is 4 and the smallest when i is 3. That is, the lens with the largest difference between the center thickness and the edge thickness may be disposed as the object-side lens of the second lens group G2, and the lens with the smallest difference may be disposed as the sensor-side lens of the first lens group G1. In addition, the average of the center thicknesses CT4, CT5, and CT6 of the fourth to sixth lenses 104, 105, and 106 may satisfy the following condition.

2.5 mm<Aver(CT4:CT6)<3.5 mm Condition:

In this way, the center thickness CT4, CT5, and CT6 of the fourth to sixth lenses 104, 105, and 106 located in the middle of the optical system 1000 is provided thickly, so that the angle of refraction of light by the lenses adjacent to the last lens 107 may be set not to be large.

FG1<0 [Equation 6]

In equation 6, FG1 is the effective focal length (EFL) of the first lens group G1 and may have a value smaller than 0. FG1 is the composite focal length of the first to third lenses. When equation 6 is satisfied, the optical aberration of the optical system, i.e., the optical aberration of the first lens group G1, may be improved. The effective focal length of the second lens group G2 is FG2, the effective focal length of the third lens is FG3, and the following equation may be satisfied.

FG2*2<|FG1| [Equation 6-1]

FG2*2<|FG1|<FG2*3 (* is multiplication) [Equation 6-2]:

|FG1|<|FG3| [Equation 6-3]:

In this way, by adjusting the focal length of each lens group, the refractive angle of light passing through the lenses may be adjusted. Here, when the effective focal length of the optical system 1000 according to the first to third modes is FMd1, FMd2, and FMd3, the following equation may be satisfied.

FMd3<|FG3| [Equation 6-4]:

FMd1<|FG1| [Equation 6-5]:

FG2*2<FMd2 [Equation 6-6]:

CRA<20 [Equation 7]

In Equation 7, CRA (Chief ray angle) is the chief ray incident angle, and in the optical system, the incident angle of the chief ray may be less than 20 degrees at the most depending on the first, second, and third modes, and may be, for example, less than 15 degrees. The first mode may be a wide mode, the second mode may be a middle mode, and the third mode may be a tele mode. Here, in the case of the first mode (Wide mode), the chief ray incident angle may be greater than the chief ray incident angle in the case of the second mode at a field of 1.0. In the case of the above third mode (Tele mode), the chief ray incident angle may be 11 degrees or less in the 1.0 field, and the chief ray incident angle of the second mode may be smaller than the chief ray incident angle of the first mode. If equation 6 is satisfied, the peripheral light ratio may be secured.

(TTL/DG1)>3.5 [Equation 8]

In equation 8, DG1 is the optical axis distance of the first lens group G1, for example, the optical axis distance from the center of the object-side surface of the first lens 101 to the center of the sensor-side surface of the third lens 103. For example, DG1 means the distance (mm) between a center of the first surface S1 of the first lens 101 and a center of the sixth surface S6 of the third lens 103 in the optical axis OA. TTL means the distance (mm) from the object-side first surface S1 of the first lens 101 to the imaging surface of the image sensor 300 in the optical axis OA. When the optical system 1000 according to the embodiment satisfies equation 8, the optical system 1000 has a relatively small TTL and can secure a peripheral light ratio.

The following equation may be further included.

(TTL/DG2)<(TTL/DG1) [Equation 8-1]

DG3<DG2 [Equation 8-2]

Here, DG2 is the optical axis distance of the second lens group G2, and is the distance from the center of the object-side surface of the fourth lens 104 to the center of the sensor-side surface of the fifth lens 105. DG3 is the optical axis distance of the third lens group G3, and is the distance from the center of the object-side surface of the sixth lens 106 to the center of the sensor-side surface of the seventh lens 107.

2<TTL/EPD3<7 [Mathematical Formula 9]

In mathematical formula 9, EPD3 means the size of the entrance pupil diameter (EPD) of the optical system 1000 when operating in the third mode, i.e., Tele mode. When the optical system 1000 according to the embodiment satisfies the equation 9, the optical system 1000 can secure a bright image when operating in the third mode, and may be a minimum condition for securing an F number of 4 or less in the tele mode. Preferably, 4<TTL/EPD3<5 may be satisfied.

4<TTL/EPD1<8 [Equation 9-1]

3<TTL/EPD2<6 [Equation 9-2]

(TTL/EPD3)<(TTL/EPD2)<(TTL/EPD1) [Equation 9-3]

In equations 9-1 to 9-3, EPD1 is the size of the entrance pupil diameter of the optical system in the first mode (Wide mode), and EPD2 is the size of the entrance pupil diameter of the optical system in the second mode (Middle mode). When the optical system satisfies the above condition, it can secure a bright image according to each mode.

3<CT_Max/CT_Min<67 [Equation 10]

In equation 10, CT_Max is the thickest thickness among the center thicknesses of the lenses, and CT_Min is the thinnest thickness among the center thicknesses of the lenses, and when equation 10 is satisfied, the optical system aberration characteristics may be improved. Preferably, 4<CT_Max/CT_Min<6 may be satisfied.

1<CA_Max/CA_Min<3 [Equation 11]

In equation 11, CA_Max is the largest effective length among the lens surfaces, and CA_Min is the smallest effective diameter among the lens surfaces, and when equation 11 is satisfied, the optical performance of the optical system may be maintained, and a camera module for a slim or compact structure may be provided. Preferably, 1<CA_Max/CA_Min<1.5 may be satisfied. Accordingly, the difference in effective length between the lens surfaces of different lenses may be set to less than 1.5 times at most.

0.1<ΣCG_Wide/TTL<0.6 [Equation 12]

In equation 12, ΣCG is the sum of the center distances between adjacent lenses, and ΣCG_Wide is the sum of the center distances between adjacent lenses in the first mode. When the optical system satisfies equation 12, the center distance DG12 between the first and second lens groups and the center distance between the second and third lens groups may be set according to the Wide mode. The center distance DG12 between the first and second lens groups may be the center distance CG3 between the third and fourth lenses 103 and 104, and varies depending on the operation mode. The center distance DG23 between the second and third lens groups may be the center distance CG5 between the fifth and sixth lenses 105 and 106, and varies depending on the operation mode. Preferably, 0.3<ΣCG_Wide/TTL<0.5 may be satisfied.

0.1<ΣCG_Mid/TTL<0.4 [Equation 12-1]

0<ΣCG_Tele/TTL<0.3 [Equation 12-2]

In equations 12-1 and 12-2, ΣCG_Mid is the sum of the center distances between adjacent lenses in the second mode, and ΣCG_Tele is the sum of the center distances between adjacent lenses in the third mode. When the optical system satisfies equations 12-1 and 12-2, the center distance DG12 between the first and second lens groups and the center distance between the second and third lens groups may be set according to the middle mode and the tele mode. Preferably, the condition of ΣCG_Tele<ΣCG_Mid<ΣCG_Wide may be satisfied. When the optical system 1000 according to the embodiment satisfies at least one or two or more of equations 1 to 12, the optical system 1000 can have a slim structure. In addition, the optical system 1000 can have improved assembly properties and a mechanically stable shape.

0.5<DG1/DG2<2 [Equation 13]

In equation 13, DG1 is the optical axis distance of the first lens group G1, and DG2 is the optical axis distance of the second lens group G2. In equation 13, the optical axis distances of the first and second lens groups G1 and G2 may be set to adjust the TTL. Preferably, 0.5<DG1/DG2<1 may be satisfied.

0.5<DG1/DG3<1.5 [Equation 13-1]

In Equation 13-1, DG3 is the optical axis distance of the third lens group G3. Preferably, 0.8<DG1/DG3<1 may be satisfied. That is, DG1<DG3 may be satisfied.

0.5<DG2/DG3<2 [Equation 14]

In Equation 14, DG2 is the optical axis distance of the second lens group G2, and DG3 is the optical axis distance of the third lens group G3. Preferably, 0.9<DG2/DG3<1.3 may be satisfied. When the optical system 1000 according to the embodiment satisfies at least one of Equations 13 and 14, it has a relatively small TTL and can provide various magnifications according to at least three mode changes.

0<CG2/TTL<0.2 [Equation 15]

In equation 15, CG2 is the optical axis distance between the second lens 102 and the third lens 103. When the optical system 1000 satisfies equation 15, the optical system 1000 has a relatively small TTL and can have improved optical characteristics by controlling stray light incident on the first lens group G1. Preferably, 0<CG2/TTL<0.1 may be satisfied.

2<TTL/(DG2+DG3)<5 [Equation 16]

Equation 16 sets TTL and the sum of the optical axis distances of the second and third lens groups G2 and G3, and when the optical system 1000 satisfies equation 16, the optical system 1000 has a relatively small TTL and can improve the chromatic aberration characteristics. Preferably, 2.2<TTL/(DG2+DG3)<3 may be satisfied.

20<Vd4−Vd5<70 [Equation 17]

In equation 17, Vd4 means the Abbe number of the fourth lens 104, and Vd5 means the Abbe number of the fifth lens 105. When the absolute value of the difference in Abbe numbers between the fourth and fifth lenses of the optical system 1000 according to the embodiment satisfies equation 17, the optical system 1000 can improve chromatic aberration characteristics. Preferably, Vd5<Vd4 may be satisfied, and 40<Vd4 may be satisfied.

15<|Vd7−Vd6|<60 [Equation 18]

In equation 18, Vd7 means the Abbe number of the seventh lens, and Vd6 means the Abbe number of the sixth lens. When the absolute value of the difference in Abbe numbers between the sixth and seventh lenses satisfies equation 18, the optical system 1000 can improve chromatic aberration characteristics. Preferably, Vd6<Vd7 may be satisfied, and 40<Vd7 may be satisfied.

1.6<Nd2 [Equation 19]

In equation 19, Nd2 means the refractive index of the second lens 102 at the d-line. When the optical system 1000 according to the embodiment satisfies equation 19, the incident light may be dispersed and the effective region of the lens arranged after the second lens 102 may be secured. Preferably, 1.65<Nd2 may be satisfied.

1.60<Nd5 [Equation 19-1]

1.65<Nd6 [Equation 19-2]

The refractive index of the fourth and seventh lenses 104 and 107 may be less than 1.6. Among the lenses, the number of lenses having a refractive index exceeding 1.60 may be greater than the number of lenses having a refractive index less than 1.60.

2<L1R1/L3R2<5 [Equation 20]

In equation 20, L1R1 means the radius of curvature of the object-side first surface S1 of the first lens 101, and L3R2 means the radius of curvature of the sensor-side sixth surface S6 of the third lens 103. When the optical system 1000 according to the embodiment satisfies equation 20, the optical system 1000 can control stray light incident on the first lens group G1. Preferably, 3<L1R1/L3R2<4 may be satisfied. Since the third lens 103 has a sensor-side surface having a concave shape on the optical axis, the effective diameter of the fourth lens 104 may be suppressed from increasing.

1.5<L1R1/L4R1<3.5 [Equation 21]

In equation 21, L1R1 means the radius of curvature of the object-side first surface S1 of the first lens 101, and L4R1 means the radius of curvature of the object-side seventh surface S7 of the fourth lens 104. When the optical system 1000 according to the embodiment satisfies equation 21, the optical system 1000 can have good optical performance at various magnifications. Preferably, 2.3<L1R1/L4R1<3 may be satisfied.

0<L3R2/L4R1<2 [Equation 22]

In equation 22, L3R2 means the radius of curvature of the sensor-side sixth surface S6 of the third lens 103, and L4R1 means the radius of curvature of the object-side seventh surface S7 of the fourth lens 104. When the optical system 1000 according to the embodiment satisfies equation 22, the optical system 1000 can have good optical performance in the periphery of the field of view (FOV) when operating at various magnifications of at least three modes. Preferably, 0.5<L3R2/L4R1<1.5 may be satisfied. The fourth lens 104 is the first lens of the second lens group G2, has a biconvex shape on the optical axis, and can have positive power. Accordingly, the gap between the convex sensor-side surface of the fourth lens 104 and the concave object-side surface of the fifth lens 105 may be tightly closed.

2<L1R1/L7R2<5 [Equation 23]

In equation 23, L7R2 means the radius of curvature of the sensor-side fourteen surface S14 of the seventh lens 107. When the optical system 1000 satisfies equation 23, the optical system 1000 can have good optical performance at the center and periphery of the FOV. Preferably, 3<L1R1/L8R2<4 may be satisfied. Here, when the radius of curvature of the object-side surface of the i-th lens is R1i and the radius of curvature of the sensor-side surface is R2i, the absolute value of R1i/R2i may be the largest when i is 3 and the smallest when i is 5. For example, when i is 3, the absolute value of R13/R23 is 5 or greater, and when i is 5, the absolute value of R15/R25 is 0.5 or less. Also, lenses with absolute values of R1i/R2i less than 1.1 may be i=1, 4, 5, 6.

0<Md12_mG2/TTL<0.5 [Equation 24]

In Equation 24, Md12_mG2 means the difference in center distance (unit: mm) after the movement of the second lens group G2 when changing from the second mode to the first mode or from the first mode to the second mode. In detail, the Md12_mG2 represents the movement distance of the second lens group G2 in the first and second modes, and means the difference value between the optical axis distance between the first and second lens groups G1 and G2 in the first mode and the optical axis distance between the first and second lens groups G1 and G2 in the second mode. When the optical system 1000 according to the embodiment satisfies equation 24, the optical system 1000 can minimize the movement distance of the second lens group G2 when the magnification is changed, so that the optical system 1000 can have a slim structure. In addition, since the movement distance may be minimized when controlling the position of the second lens group G2, it can have improved power consumption characteristics. Preferably, 0<Md12_mG2/TTL<0.2 may be satisfied.

0<Md23_mG2/TTL<0.5 [Equation 25]

In equation 25, Md23_mG2 means the difference (unit: mm) in the center distance after the movement of the second lens group G2 when operating from the second mode to the third mode, or from the third mode to the second mode. In detail, Md23_mG2 means the difference value between the optical axis distance between the first and second lens groups G1 and G2 in the second mode and the optical axis distance between the first and second lens groups G1 and G2 in the third mode. The maximum movement distance of the second lens group G2 may be greater than the maximum movement distance of the third lens group G3. When the optical system 1000 according to the embodiment satisfies the equation 25, the optical system 1000 can minimize the movement distance of the second lens group G2 when the magnification is changed, so that the optical system 1000 can have a slim structure. In addition, the movement distance may be minimized when the position of the second lens group G2 is controlled, so that it can have improved power consumption characteristics. It can satisfy 0<Md23_mG2/TTL<0.1. In addition, it can satisfy the condition of Md23_mG2<Md12_mG2.

0.3<Md12_mG2/DG2<1 [Equation 26]

Equation 26 may set the movement distance of the second lens group G2 and the optical axis distance of the second lens group G2. When the optical system 1000 satisfies equation 26, the optical system 1000 can minimize the movement distance of the second lens group G2 when the magnification is changed, so that the optical system 1000 can have a slim structure. In addition, the movement distance may be minimized when the position of the second lens group G2 is controlled, so that it can have improved power consumption characteristics. Preferably, 0.3<Md12_mG2/DG2<0.8 may be satisfied.

0<Md23_mG3/DG3<0.5 [Equation 27]

In equation 27, Md23_mG3 means the difference in the center distance after the movement of the third lens group G3 when changing from the second mode to the third mode, or from the third mode to the second mode. When the optical system 1000 satisfies equation 27, the optical system 1000 may minimize the movement distance of the third lens group G3 when the magnification is changed, so that the optical system 1000 may have a slim structure. In addition, the movement distance may be minimized when the position of the third lens group G3 is controlled, so that it can have improved power consumption characteristics. Preferably, 0.1<Md23_mG3/DG3<0.4 may be satisfied.

1<(CT1/ET1)/(CT3/ET3)<5 [Equation 28]

In equation 28, CT1/ET1 is a value obtained by dividing the thickness of the first lens 101 in the optical axis by the thickness at the end, and CT3/ET3 is a value obtained by dividing the thickness of the optical axis of the third lens 103 by the thickness at the end. If the value obtained by dividing the center thickness and the end thickness of the first and third lenses 101 and 103 satisfies the equation 28 with the above ratio, chromatic aberration may be improved and incident light may be controlled. Preferably, 1<(CT1/ET1)/(CT3/ET3)<3 may be satisfied.

0<(CT1/ET1)/(CT7/ET7)<2 [Equation 29]

In equation 29, CT1/ET1 is a value obtained by dividing the thickness of the seventh lens 107 at the optical axis by the thickness at the end. If the values obtained by dividing the center thickness and the end thickness of the first and seventh lenses 101 and 107 satisfy equation 29, chromatic aberration may be improved and incident light may be controlled. Preferably, 0.5<(CT1/ET1)/(CT7/ET7)<1.5 may be satisfied.

2<(CT4/ET4)/(CT5/ET5)<3.5 [Equation 29-1]

In Equation 29-1, CT4/ET4 is a value obtained by dividing the thickness of the optical axis of the fourth lens 104 by the thickness at the end. If the values obtained by dividing the center thickness and the end thickness of the fourth and fifth lenses 104 and 105 satisfy Equation 29-1, chromatic aberration may be improved within the second lens group G2 and the incident light may be controlled.

1<Md1(DG12/DG23)<5 [Equation 30]

In Equation 30, Md1(DG12/DG23) means the ratio between the center distance DG12 between the first and second lens groups in the first mode and the center distance DG23 between the second and third lens groups. When the optical system 1000 according to the embodiment satisfies the equation 30, the optical system 1000 can have improved optical characteristics at the first magnification. In detail, the optical system 1000 can have improved aberration characteristics at the first magnification, and can improve optical performance at the center and the periphery of the FOV. Preferably, 1<Md1 (DG12/DG23)<2 may be satisfied.

0<Md3(DG12/DG23)<0.7 [Equation 31]

In equation 31, Md3 (DG12/DG23) means the ratio between the center distance DG12 between the first and second lens groups in the third mode and the center distance DG23 between the second and third lens groups. When the optical system 1000 according to the embodiment satisfies equation 31, the optical system 1000 can have improved optical characteristics at the second magnification. In detail, the optical system 1000 can have improved aberration characteristics at the second magnification and improve optical performance at the periphery portion of the FOV. Preferably, 0<Md3 (DG12/DG23)<0.5 may be satisfied.

0.5<TD2/TTL<1 [Equation 32]

In equation 32, TD2 is the optical axis distance from the center of the object-side surface of the first lens to the center of the sensor-side surface of the seventh lens in the second mode. When the optical system 1000 according to the embodiment satisfies equation 32, the optical system 1000 can have improved optical characteristics in the middle mode, which is the second mode. In detail, the optical system 1000 has improved aberration characteristics in the middle mode and can improve optical performance in the periphery portion of the FOV. Preferably, it can satisfy 0.65<TD2/TTL<0.9.

1<TD1/TD2<1.5 [Equation 33]

In Equation 33, TD1 is an optical axis distance from the center of the object-side surface of the first lens to the center of the sensor-side surface of the seventh lens in the first mode. When the optical system 1000 according to the embodiment satisfies Equation 33, the optical system 1000 can have improved optical characteristics in the first and second modes and can reduce the influence on TTL. In detail, the optical system 1000 has improved aberration characteristics in the first and second modes and can improve optical performance in the periphery portion of the FOV. Preferably, it can satisfy 1<TD1/TD2<1.4.

0.5<TD1/TTL<1 [Equation 33-1]

Preferably, 0.7<TD1/TTL<0.95 may be satisfied. The relationship between the maximum optical axis distance TD1 and TTL according to each mode may be set.

1<TD1/TD3<1.5 [Equation 33-2]

In equation 33-2, TD3 is the optical axis distance from the center of the object-side surface of the first lens to the center of the sensor-side surface of the seventh lens in the third mode. The optical system 1000 can have improved optical characteristics in the first and third modes, and can reduce the influence on TTL.

13 mm<TD3<TD2<TD1<25 mm [Equation 34]

Equation 34 is a drawing comparing the optical axis distances of lenses in the first, second, and third modes, and TD3 is the optical axis distance from the center of the object-side surface of the first lens to the center of the sensor-side surface of the seventh lens in the third mode. When the optical system 1000 according to the embodiment satisfies equation 34, the optical system 1000 can have improved optical characteristics in the first, second, and third modes. In detail, the optical system 1000 can have improved aberration characteristics in the first, second, and third modes and improve the optical performance of the periphery portion of the FOV.

0.1<BFL2/TTL<1 [Equation 35]

In equation 35, BFL2 (Back focal length 2) is the optical axis distance from the center of the sensor-side surface of the seventh lens to the imaging surface of the image sensor in the second mode. When the optical system 1000 according to the embodiment satisfies equation 35, the optical system 1000 can adjust the focus position to the imaging surface of the image sensor 300 in the second mode. In detail, the optical system 1000 has improved optical characteristics in the second mode and can improve the optical performance of the periphery portion of the FOV. Preferably, 0.2<BFL2/TTL<0.4 may be satisfied.

2<BFL3/BFL1<4 [Equation 36]

In equation 36, BFL3 is the optical axis distance from the center of the sensor-side surface of the seventh lens to the imaging surface of the image sensor in the third mode. When the optical system 1000 according to the embodiment satisfies the equation 36, the optical system 1000 can adjust the focus position toward the imaging surface of the image sensor 300 in the first and third modes. In detail, the optical system 1000 has improved optical characteristics in the first and third modes and can improve the optical performance of the periphery portion of the FOV. Preferably, it may satisfy 2.2<BFL3/BFL1<3.

2<TD3/BFL3<5 [Equation 37]

Equation 37 is a value comparing the optical axis distance TD3 between the center of the object-side surface of the first lens and the center of the sensor-side surface of the seventh lens 107 in the third mode, and the optical axis distance (BFL3) from the center of the sensor-side surface of the seventh lens 107 to the imaging surface of the image sensor. When the optical system 1000 according to the embodiment satisfies equation 37, the optical system 1000 can have improved optical characteristics in the third mode. Specifically, the optical system 1000 can have improved aberration characteristics in the third mode and improve optical performance in the periphery portion of the FOV. Preferably, 2.5<TD3/BFL3<4 may be satisfied.

2<Md_CG_Max/Md_CG_Min<8 [Equation 38]

In equation 38, Md_CG_Max means the maximum center distance among the center distances between the first to seventh lenses in the first, second, and third modes, and Md_CG_Min means the minimum center distance among the center distances between the first to seventh lenses in the first, second, and third modes. When the optical system satisfies equation 38, the TTL and the optical axis distances of the lenses may be adjusted according to each mode. Preferably, 4<Md_CG_Max/Md_CG_Min<7 may be satisfied.

1 mm<BFL1<6 mm [Equation 39]

Equation 39 means the optical axis distance between the seventh lens and the image sensor in the first mode. When the optical system satisfies equation 39, the focus position toward the image surface of the image sensor in the first mode may be adjusted. Preferably, 2 mm<BFL1<3.5 mm may be included.

20<Aver_Vd<45 [Equation 40]

In equation 40, Aver_Vd is the average of Abbe numbers of the first to seventh lenses. When the optical system satisfies equation 40, the optical system 1000 can have improved aberration characteristics and resolution. Preferably, 25<Aver_Vd<40 may be satisfied.

1.5<Aver_Nd<1.8 [Equation 41]

In equation 40, Aver_Nd is the average of the refractive indices of the first to seventh lenses. When the optical system satisfies equation 41, the optical system 1000 can have improved aberration characteristics and resolution. Preferably, 1.58<Aver_Nd<1.63 may be satisfied.

10<ΣVd/ΣNd<40 [Equation 41-1]

In equation 41-1, ΣVd means the sum of the Abbe numbers of each of the plurality of lenses. ΣNd means the sum of the refractive indices of each of the plurality of lenses. When the optical system 1000 according to the embodiment satisfies equation 41-1, the optical system 1000 can have improved aberration characteristics and resolution. Preferably, the equation 41-1 may satisfy 17<ΣVd/ΣNd<25. Preferably, the following condition may satisfy: (ΣVd−ΣNd)<225.

1.5<|FG1/FG2|<4 [Equation 42]

In equation 42, FG1 means the effective focal length (EFL) of the first lens group G1, and FG2 means the effective focal length of the second lens group G2. FG2 is the composite focal length of the fourth and fifth lenses. When equation 42 is satisfied, the size of the optical system, for example, the TTL, may be reduced. Preferably, FG2>0 is satisfied. FG3 is the composite focal length of the sixth and seventh lenses, and FG3<0, and the following condition may satisfy: |FG3|>|FG1|>FG2. Preferably, 1.8<FG1/FG2<3 may be satisfied.

1<FMd2/FMd1<10 [Equation 43]

In Equation 43, FMd1 is the effective focal length of the optical system in the first mode, and FMd2 is the effective focal length of the optical system in the second mode. Preferably, 1<FMd2/FMd1<3 may be satisfied. When the optical system satisfies Equation 43, the effective focal length may be adjusted according to the first and second modes.

1<FMd3/FMd2<10 [Equation 43-1]

In Equation 43, FMd3 is the effective focal length of the optical system in the third mode. Preferably, 1<FMd3/FMd2<2 may be satisfied, and the following condition may satisfy: (FMd3/FMd1)>(FMd3/FMd2). When the optical system satisfies equation 43-1, the effective focal length may be adjusted according to the second and third modes.

In the first mode, the effective focal length (Fmd1) of the optical system and the focal length of each lens can satisfy the following conditions.

5<F1/Fmd1<13 Condition 1:

1<F2/Fmd1<4 Condition 2:

0<|F3/Fmd1|<1 Condition 3:

0<F4/Fmd1<1 Condition 4:

1<|F5/Fmd1|<4 Condition 5:

5<F6/Fmd1<30 Condition 6:

1.5<|F7/Fmd1|<5 Condition 7:

In the second mode, the effective focal length (Fmd2) of the optical system and the focal length of each lens may satisfy the following conditions.

0<F1/Fmd2<1 Condition 1:

0.5<F2/Fmd2<2 Condition 2:

1<|F3/Fmd2|<4 Condition 3:

2<F4/Fmd2<5 Condition 4:

0.3<|F5/Fmd2|<1.5 Condition 5:

0<F6/Fmd2<0.5 Condition 6:

0.2<|F7/Fmd2|<1.5 Condition 7:

In the third mode, the effective focal length (Fmd3) of the optical system and the focal length of each lens may satisfy the following conditions.

0<F1/Fmd3<0.6 Condition 1:

0.3<F2/Fmd3<2 Condition 2:

1<|F3/Fmd3|<5 Condition 3:

1.2<F4/Fmd3<6 Condition 4:

0.3<|F5/Fmd3|<2 Condition 5:

0<F6/Fmd3<0.5 Condition 6:

0.2<|F7/Fmd3|<2 Condition 7:

2<FMd2/EPD2<7 [Equation 44]

In Equation 44, FMd2 is the effective focal length of the optical system in the second mode (Middle), and EPD2 means the size of the EPD of the optical system 1000 in the second mode. When the optical system 1000 according to the embodiment satisfies equation 44, the optical system 1000 can secure a bright image when the second mode is operated. Preferably, 2<FMd2/EPD2<4 may be satisfied.

0.1<FMd1/EPD1<3 [Equation 45]

In equation 34, FMd1 is an effective focal length of the optical system in the first mode (Wide), and EPD1 means the size of the EPD of the optical system 1000 when the first mode is operated. When the optical system 1000 according to the embodiment satisfies equation 45, the optical system 1000 can secure a bright image when the first mode is operated. Preferably, 1<FMd1/EPD1<3 may be satisfied.

FMd1<FMd2<FMd3 [Equation 46]

In equation 46, FMd1, FMd2, and FMd3 mean the effective focal lengths of the optical system in the first, second, and third modes. The effective focal length in the third mode may be the largest, and the effective focal length in the first mode may be the smallest. Preferably, 5 mm<FMd1<FMd2<FMd3<25 mm may be satisfied.

0<TTL/FMd2<2 [Equation 47]

Equation 47 may adjust the TTL by comparing the effective focal lengths in the TTL and the second mode. Preferably, 1<TTL/FMd2<2 may be satisfied.

0.1<TTL/FMd1<5 [Equation 48]

Equation 47 may adjust the TTL by comparing the effective focal lengths in the TTL and the first mode. Preferably, 1<TTL/FMd1<3 may be satisfied.

1<CA_Max/ImgH<3 [Equation 49]

In equation 49, CA_Max means the largest effective length (CA) among the lens surfaces of the lenses included in the optical system 1000. ImgH is the distance from the 0-field region of the image sensor 300 centering on the image surface overlapping the optical axis OA to the 1.0 field region of the image sensor 300. The ImgH means ½ of the maximum diagonal length of the effective region of the image sensor 300. When the optical system 1000 according to the embodiment satisfies equation 49, the optical system 1000 may be provided in a slim and compact manner. In addition, the optical system 1000 can implement high resolution and high image quality. The range of the above ImgH is 2 mm or more, for example, 2 mm to 3 mm.

Here, the effective lengths CA1 to CA7 of the first to seventh lenses 101-107 can satisfy the following conditions.

0.5<CA1/(Imgh*2)<1.5 Condition 1:

Preferably, CA1>(Imgh*2) may be satisfied.

0.4<CA2/(Imgh*2)<1.4 Condition 2:

Preferably, CA2>(Imgh*2) may be satisfied.

And, the following conditions may satisfy: CA3<(Imgh*2), CA5<(Imgh*2), CA6<(Imgh*2), CA7<(Imgh*2). In addition, the following condition may satisfy: CA4>(Imgh*2). When the effective length of the object-side surface of the first lens 101 is CA11 and the effective length of the sensor-side surface is CA12, the following conditions may be satisfied.

1<CA11/(Imgh*2)<1.5 Condition 1:

0.8<CA12/(Imgh*2)<1.2 Condition 2:

5<TTL/ImgH<12 [Equation 50]

When the optical system 1000 satisfies equation 39, the optical system 1000 can have a smaller TTL, so that the optical system 1000 may be provided in a slim and compact manner. Preferably, it may be in the range of 6<TTL/ImgH<10.

1<BFL2/ImgH<3 [Equation 51]

If the optical system 1000 according to the embodiment satisfies equation 51, the BFL required for a small image sensor of less than 1 inch may be secured. In addition, if the optical system 1000 satisfies equation 51, the optical system 1000 can operate at various magnifications while maintaining TTL, and can have excellent optical characteristics at the center and periphery portions of the FOV. Preferably, it may be in the range of 2<BFL2/ImgH<3.2.

2<BFL3/ImgH<4 [Equation 52]

If the optical system 1000 according to the embodiment satisfies equation 52, the BFL required for a small image sensor of less than 1 inch may be secured. When the optical system 1000 satisfies the equation 52, the optical system 1000 can operate at various magnifications while maintaining TTL, and can have excellent optical characteristics at the center and periphery portions of the FOV. Preferably, 2.5<BFL3/ImgH<3.5 may be satisfied.

1<EPD1<EPD2<EPD3<7 [Equation 53]

In equation 53, EPD1, EPD2, and EPD3 mean sizes of the entrance pupil diameter of the optical system according to the first to third modes, and can adjust the brightness according to each mode.

0<Max_Distortion<3 [Equation 54]

In equation 54, distortion means the maximum value or maximum value of distortion from the center (0.0F) of the image sensor to the diagonal end (1.0F) based on the optical characteristics detected by the image sensor 300. When the optical system 1000 satisfies equation 54, the optical system 1000 can improve the distortion characteristics and set conditions for image processing. Preferably, Max_Distortion<1.5 may be satisfied.

8°<FOV3<FOV2<FOV1<450 [Equation 55]

In equation 55, FOV1, FOV2, and FOV3 mean the diagonal field of view of the optical system in the first, second, and third modes. FOV refers to the field of view (Degree) in the diagonal direction of the optical system 1000, and can provide an optical system of less than 45 degrees.

In addition, the relationship between the field of view (FOV1, FOV2, FOV3) according to each mode and the optical axis distance (BFL1, BFL2, BLF3) between the last lens and the image sensor 300 can satisfy the following conditions.

5<FOV1/BFL1<15 Condition 1:

2<FOV2/BFL2<5 Condition 2:

1<FOV3/BFL3<3 Condition 3:

The optical system can set the relationship between the ½ angle of the filed of view and the CRA as in Condition 4 below.

0.5<HFOV/CRA<1.5 Condition 4:

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + … \qquad [ Equation 56 ]$$

In Equation 56, Z can mean Sag, which is the distance in the direction of the optical axis from an arbitrary position on the aspherical surface to the vertex of the aspherical surface. In addition, Y can mean the distance in the direction perpendicular to the optical axis from an arbitrary position on the aspherical surface to the optical axis. In addition, c can mean the curvature of the lens, and K can mean the conic constant. In addition, A, B, C, D, E, and F can mean aspheric coefficients.

The optical system 1000 according to the embodiment can satisfy at least one of the equations 1 to 55 described above. Accordingly, the optical system 1000 and the camera module can have improved optical characteristics. Specifically, since the optical system 1000 satisfies at least one or two or more equations of the equations 1 to 55 described above, it can effectively correct optical characteristic degradation such as chromatic aberration, vignetting, diffraction effect, and deterioration of image quality in the periphery region caused by movement of the lens group. In addition, the optical system 1000 according to the embodiment can significantly reduce the movement distance of the lens group and provide an autofocus (AF) function for various magnifications with excellent power consumption characteristics.

Since the optical system 1000 according to the embodiment satisfies at least one or two or more of the equations 1 to 55 described above, it can have improved assembly properties and have a mechanically stable form, and is provided with a slim structure, so that the optical system 1000 and the camera module including it can have a compact structure.

Hereinafter, the optical system 1000 according to the embodiment and the first to third mode changes will be described in more detail. In the optical system 1000 according to the embodiment, the first lens group G1 may be fixed, and the second lens group G2 and the third lens group G3 can move according to the operation mode. The first lens group G1 can include three lenses, for example, the first to third lenses 101, 102, and 103, and the second lens group G2 can include two lenses, for example, the fourth and fifth lenses 104 and 105. In addition, the third lens group G3 can include two lenses, for example, the sixth and seventh lenses 106 and 107. In the optical system 1000 according to the embodiment, the object-side surface (the seventh surface S7) of the fourth lens 104 can function as an aperture stop, and the optical filter 500 described above may be arranged between the fourth lens group G4 and the image sensor 300.

FIG. 5 shows the radius of curvature on the optical axis OA of the first to seventh lenses 101 to 107, the center thickness (CT) of the lenses, the center distance (CG) between adjacent lenses, the refractive index at the d-line, the Abbe number, and the effective length (CA). In FIG. 5, DG4 is the optical axis distance between the seventh lens and the optical filter 500, and may be varied according to the movement of the third lens group G3.

TABLE 1

| Lens groups | Lenses | CT/ET |
|---|---|---|
| First lens group | First Lens | 0.995 |
| | Second lens | 1.444 |
| | Third lens | 0.474 |
| Second lens group | Fourth lens | 2.573 |
| | Fifth lens | 0.915 |
| Third lens group | Sixth lens | 1.030 |
| | Seventh lens | 0.820 |

Referring to Table 1, the ratio CT/ET of the center thickness CT and edge thickness ET of each lens of the plurality of lenses may be different from each other, and the CT/ET value of the fourth lens 104 may be the largest, and the CT/ET value of the third lens may be the smallest.

As shown in FIGS. 1 and 2, the Abbe number Vd4 of the fourth lens 104 included in the second lens group G2 may be 20 or higher than the Abbe number Vd5 of the fifth lens 105. Since the fourth lens 104 and the fifth lens 105 have the above-described Abbe number difference, the chromatic aberration change that occurs when the magnification changes according to the movement (M1) of the second lens group G2 may be minimized. As shown in FIG. 1 and FIG. 3, the Abbe number Vd7 of the seventh lens 107 included in the third lens group G3 may be 20 or more or 30 or more higher than the Abbe number Vd6 of the sixth lens 106. Since the sixth lens 106 and the seventh lens 107 have the above-described Abbe number difference, the chromatic aberration change that occurs when the magnification changes according to the movement (M2) of the third lens group G3 may be minimized and/or compensated to perform an achromatic function.

The camera module according to the embodiment may obtain information about the subject at various magnifications. In detail, the driving member may control the positions of the second lens group G2 and the third lens group G3, and through this, the camera module may operate at various magnifications. For example, referring to FIGS. 1, 8, and 11, the camera module including the optical system 1000 may operate in the first mode having the first magnification. The first magnification may be about 3 to about 5 times. In detail, in an embodiment, the first magnification may be about 3.5 times. In the first mode, each of the second lens group G2 and the third lens group G3 may be moved to a set position. Accordingly, each of the first to third lens groups G3 may be disposed at a set interval. For example, the second lens group G2 may be positioned in a region spaced apart from the first lens group G1 by a first distance DG12, and the third lens group G3 may be positioned in an area spaced apart from the second lens group G2 by a second distance DG23. Here, the first to second distances DG12 and DG23 may mean intervals between the lens groups in the optical axis OA, and may vary depending on the operation mode.

When the camera module operates in the first mode, the optical system 1000 may have a TTL value and a BFL1 value at the first position. In addition, the optical system 1000 may have an FMD1 defined as a first effective focal length (EFL) at the first position. In addition, the FOV of the camera module in the first mode may be less than about 35 degrees, and the F-number may be less than about 3. When the camera module operates in the second mode, the optical system 1000 may have a TTL value and a BFL2 value at the second position. In addition, the optical system 1000 may have FMD2 defined as a second effective focal length (EFL) at the second position. In addition, the FOV of the camera module in the second mode may be less than about 25 degrees, and the F-number may be less than about 3.4. When the camera module operates in the third mode, the optical system 1000 may TTL value and a BFL3 value at the third position. In addition, the optical system 1000 may have FMD3 defined as a third effective focal length (EFL) at the third position. In addition, the FOV of the camera module in the third mode may be less than about 20 degrees, and the F-number may be less than about 4.

As shown in FIG. 6, the relative illumination (RI) in each mode can change depending on the height of the image sensor, and it may be seen that the relative illumination at the periphery or edge (1.0 Field) at the height (Field Height) of the image sensor is 50% or more. The optical system 1000 can have excellent aberration characteristics as shown in FIGS. 8 and 11 in the first mode. In detail, FIG. 8 is a graph for the diffraction MTF characteristics of the optical system 1000 operating in the first mode (first magnification), and FIG. 11 is a graph for the aberration characteristics. The diffraction MTF characteristics graph is measured in units of approximately 0.252 mm over a spatial frequency range of 0.000 mm to 2.2520 mm. In the diffraction MTF graph, T represents the MTF change in spatial frequency per millimeter of the tangential image, and R represents the MTF change in spatial frequency per millimeter of the radial image. Here, the MTF (Modulation Transfer Function) depends on the spatial frequency of cycles per millimeter.

In the aberration graph of FIG. 11, it is a graph that measures spherical aberration (Longitudinal Spherical Aberration), astigmatic field curves, and distortion from left to right. In FIG. 8, the X-axis can represent the focal length (mm) and distortion (%), and the Y-axis can mean the height of the image. In addition, the graph for spherical aberration is a graph for light in wavelength bands of about 435 nm, about 486 nm, about 546 nm, about 587 nm, and about 656 nm, and the graph for astigmatism and distortion aberration is a graph for light in wavelength bands of 546 nm. In the aberration diagram of FIG. 11, it may be interpreted that the closer each curve is to the Y-axis, the better the aberration correction function is. Referring to FIG. 11, it may be seen that the optical system 1000 according to the embodiment has measurement values close to the Y-axis in almost all regions.

Table 2 and FIG. 3 are about the items of the mathematical formulas described above in the optical system 1000 of the embodiment, including the TTL (mm), BFL, effective focal length (F) (mm), ImgH (mm), effective length (CA) (mm), thickness (mm), TTL (mm), optical axis distance TD (mm) from the first surface S1 to the fourteenth surface S14, focal lengths F1, F2, F3, F4, F5, F6, and F7 (mm) of each of the first to seventh lenses, sum of refractive indices of each lens, sum of Abbe numbers of each lens, sum (mm) of center thicknesses of each lens, sum of center distances between adjacent lenses, effective diameter, diagonal FOV (Degree), edge thickness (ET), focal lengths of the first and second lens groups, F number, etc.

TABLE 2

| Items | Embodiment | Items | Embodiment |
|---|---|---|---|
| F1 | 100.000 | ET1 | 1.496 |
| F2 | 14.155 | ET2 | 0.905 |
| F3 | −5.840 | ET3 | 1.189 |
| F4 | 4.839 | ET4 | 0.818 |
| F5 | −20.092 | ET5 | 3.279 |
| F6 | 201.343 | ET6 | 2.914 |
| F7 | −23.720 | ET7 | 1.747 |
| FG1 | −14.730 | ΣCG_Wide | 9.256 |
| FG2 | 6.751 | ΣCG_Mid | 5.216 |
| FG3 | −22.951 | ΣCG_Tele | 4.356 |
| ΣIndex | 11.315 | ImgH | 2.520 |
| ΣAbbe | 226.996 | TTL | 25.168 |
| ΣCT | 12.897 | | |

Table 3 shows the center distance between the first and second lens groups according to the first to third modes, the center distance between the second and third lens groups, the center distance between the seventh lens and the optical filter DG4, the effective focal length (EFL) according to each mode, the entrance pupil size (EPD) according to each mode, the optical axis distance (TD) of the lens according to each mode, the F number and angle of view, and the BFL according to each mode.

TABLE 3

| | First | | |
|---|---|---|---|
| Items | mode | Second mode | Third mode |
| DG12 (mm) | 4.919 | 2.035 | 0.606 |
| DG23 (mm) | 3.281 | 2.126 | 2.694 |
| DG4 (mm) | 1.916 | 5.858 | 6.716 |
| EFL(FMd1/FMd2/FMd3) (mm) | 10.2465 | 15.6 | 19.1304 |
| EPD(EPD1/EPD2/EPD3) | 4.178 | 4.952 | 5.452 |
| TD(TD1/TD2/TD3) (mm) | 22.152 | 18.113 | 17.253 |
| F-number | 2.453 | 3.15 | 3.509 |
| FOV (Degree) | 29.940 | 19.776 | 16.129 |
| BFL (BFL1/BFL2/BFL3) (mm) | 3.016 | 7.055 | 7.915 |

Tables 4 and 5 are results for the equations 1 to 55 described above in the optical system 1000 of the embodiment. Referring to Table 5, it may be seen that the optical system 1000 satisfies at least one, two or more, or three or more of the equations 1 to 55. In detail, it may be seen that the optical system 1000 according to the embodiment satisfies all of the equations 1 to 55. Accordingly, the optical system 1000 can have good optical performance and excellent optical characteristics at the center and periphery portions of the FOV.

TABLE 4

| | |
|---|---|
| Equations | Embodiment |

| | | |
|---|---|---|
| 1 | nL_G1 > nL_G3 | Satisfaction |
| 2 | 0.7 < CA41 / CA11 < 1.5 | 0.897 |
| 3 | 1 < CT1 / CT3 < 4 | 2.642 |
| 4 | 0 < CT1 / CT4 < 1 | 0.707 |
| 5 | 1 < ET3 / CT3 < 4 | 2.111 |
| 6 | FG1 < 0 | −14.730 |
| 7 | CRA < 20 | Satisfaction |
| 8 | (TTL / DG1) > 3.5 | 6.052 |
| 9 | 2 < TTL / EPD3 < 7 | 4.616 |
| 10 | 3 < CT_Max/CT_Min < 7 | 5.325 |
| 11 | 1 < CA_Max/CA_Min < 3 | 1.256 |
| 12 | 0.1 < ΣCG_Wide /TTL < 0.6 | 0.368 |
| 13 | 0.5 < DG1 / DG2 < 2 | 0.790 |
| 14 | 0.5 < DG2 / DG3 < 2 | 1.161 |
| 15 | 0 < CG2 / TTL < 0.2 | 0.027 |
| 16 | 2 < TTL/(DG2 + DG3) < 5 | 2.570 |
| 17 | 20 < \|Vd4 \| − Vd5 < 70 | 35.293 |
| 18 | 15 < \|Vd7 − Vd6\| < 60 | 36.469 |
| 19 | 1.6 < Nd2 | 1.628 |
| 20 | 2 < L1R1 / L3R2 < 5 | 3.461 |
| 21 | 1.5 < L1R1 / L4R1 < 3.5 | 2.878 |
| 22 | 0 < L3R2 / L4R1 < 2 | 0.831 |
| 23 | 2 < L1R1 / L7R2 < 5 | 3.240 |
| 24 | 0 < Md12_mG2 / TTL < 0.5 | 0.115 |
| 25 | 0 < Md23_mG2 / TTL < 0.5 | 0.046 |
| 26 | 0.3 < Mde12_mG2 / DG2 < 1 | 0.548 |
| 27 | 0 < Md23_mG3 / DG3 < 0.5 | 0.255 |
| 28 | 1 < (CT1/ET1) / (CT3/ET3) < 5 | 2.101 |
| 29 | 0 < (CT1/ET1)/ (CT7/ET7) < 2 | 1.214 |
| 30 | 1 < Md1 (DG12 / DG23) < 5 | 1.499 |

TABLE 5

| | |
|---|---|
| Equations | Embodiment |

| | | |
|---|---|---|
| 31 | 0 < Md3 (DG12 / DG23) < 0.7 | 0.225 |
| 32 | 0.5 < TD2/TTL < 1 | 0.720 |
| 33 | 1 < TD1 / TD2 < 1.5 | 1.223 |
| 34 | 13 < TD3 < TD2 < TD1 < 25 | Satisfaction |
| 35 | 0.1 < BFL2 / TTL < 1 | 0.280 |
| 36 | 2 < BFL3 / BFL1 < 4 | 2.625 |
| 37 | 2 < TD3 /BFL3 < 5 | 3.180 |
| 38 | 2 < Md_CG_Max / Md_CG_Min < 8 | 4.703 |
| 39 | 1 < BFL1 < 6 | 3.016 |
| 40 | 20 < Aver_Vd < 45 | 32.428 |
| 41 | 1.5 < Aver_Nd < 1.8 | 1.616 |
| 42 | 1.5 < \| FG1 / FG2 \| < 4 | 2.182 |
| 43 | 1 < FMd2 / FMd1 < 10 | 1.522 |
| 44 | 2 < FMd2 / EPD2 < 7 | 3.150 |
| 45 | 0.1 < FMd1 / EPD1 < 3 | 2.453 |
| 46 | FMd1 < FMd2 < FMd3 | Satisfaction |
| 47 | 0 < TTL / FMd2 < 2 | 1.613 |
| 48 | 0.1 < TTL / FMd1 < 5 | 2.456 |
| 49 | 1 < CA_Max / ImgH < 3 | 2.302 |
| 50 | 5 < TTL / ImgH < 12 | 9.987 |
| 51 | 1 < BFL2/ImgH < 3 | 2.800 |
| 52 | 2 < BFL3/ ImgH < 4 | 3.141 |
| 53 | 1 < EPD1 < EPD2 < EPD3 < 7 | Satisfaction |
| 54 | 0 < Max_Distortion < 3 | 1.200 |
| 55 | 8 < FOV3 < FOV2 < FOV1 < 45 | Satisfaction |

The optical system and camera module according to the embodiment may satisfy at least one or two of the equations 1 to 30 and/or the equations 31 to 55, or may satisfy all the equations.

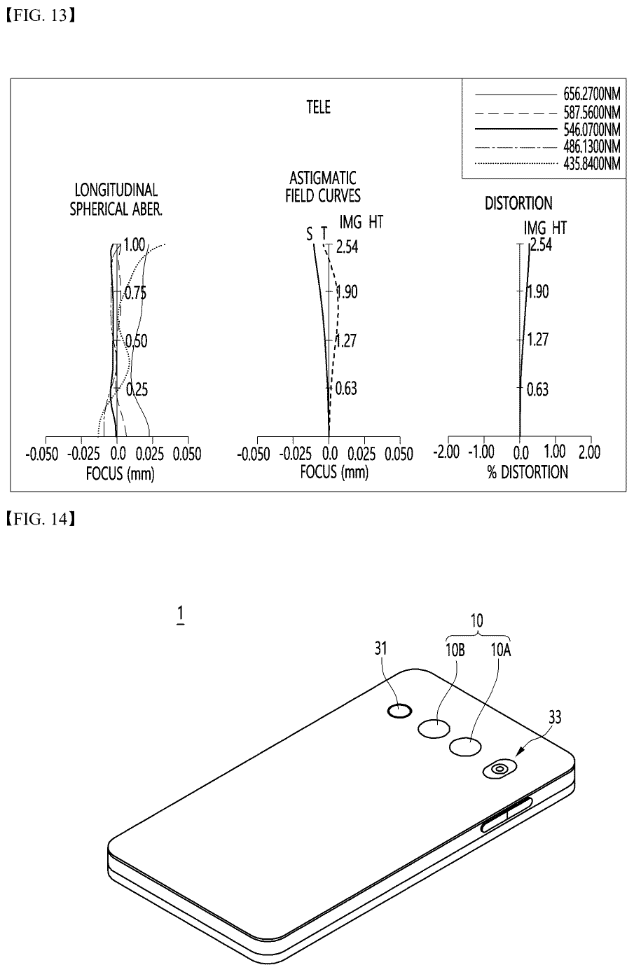

FIG. 14 is a drawing illustrating a camera module according to an embodiment applied to a mobile terminal. Referring to FIG. 14, the mobile terminal 1 can include the camera module 10 disclosed in the embodiment on the rear side. As another example, the mobile terminal 1 can include the camera module disclosed in the embodiment on the front side. The camera module 10 can include an image capturing function. In addition, the camera module 10 can include at least one of an auto focus, a zoom function, and an OIS function.

The camera module 10 can process a still image or a video frame obtained by the image sensor 300 in a shooting mode or a video call mode. The processed image frame may be displayed on the display unit (not shown) of the mobile terminal 1 and stored in the memory (not shown). In addition, although not shown in the drawing, the camera module may be further arranged on the front of the mobile terminal 1. For example, the camera module 10 may include a first camera module 10A and a second camera module 10B. At this time, at least one of the first camera module 10A and the second camera module 10B may include the optical system 1000 described above. Accordingly, the camera module 10 may have a slim structure and may capture a subject at various magnifications.

The mobile terminal 1 may further include an autofocus device 31. The autofocus device 31 may include an autofocus function using a laser. The autofocus device 31 may be mainly used in conditions where the auto-focus function using the image of the camera module 10 is degraded, for example, in a close range of 10 m or less or in a dark environment. The autofocus device 31 can include a light-emitting unit including a vertical cavity surface-emitting laser (VCSEL) semiconductor element, and a light-receiving unit converting light energy into electric energy, such as a photodiode. The mobile terminal 1 can further include a flash module 33. The flash module 33 can include a light-emitting element that emits light inside. The flash module 33 can emit light in a visible light wavelength band. For example, the flash module 33 can emit white light or light of a color similar to white. However, the embodiment is not limited thereto, and the flash module 33 can emit light of various colors. The flash module 33 may be operated by the camera operation of the mobile terminal or the control of the user. The features, structures, effects, etc. described in the embodiments above are included in at least one embodiment of the present invention, and are not necessarily limited to one embodiment.

Features, structures, effects, etc. described in the embodiments are included in at least one embodiment of the invention, and are not necessarily limited to only one embodiment. Furthermore, features, structures, effects, etc. illustrated in each embodiment may be combined or modified for other embodiments by those of ordinary skill in the art to which the embodiments belong. Accordingly, the contents related to such combinations and modifications should be interpreted as being included in the scope of the invention. In addition, although the embodiment has been described above, it is only an example and does not limit the invention, and those of ordinary skill in the art to which the invention pertains are exemplified above in a range that does not depart from the essential characteristics of the present embodiment. It may be seen that various modifications and applications that have not been made are possible. For example, each component specifically shown in the embodiment may be implemented by modification. And the differences related to these modifications and applications should be construed as being included in the scope of the invention defined in the appended claims.

1-20. (canceled)

21. An optical system comprising:
first to third lens groups arranged along an optical axis from an object toward a sensor side and each lens group of which includes at least one lens,
wherein the first lens group and the third lens group have positive power,
wherein the second lens group has negative power,
wherein a position of the first lens group is fixed,
wherein each of the second and third lens groups moves along the optical axis according to an operation mode,
wherein a first lens of the first lens group closest to the object has positive power,
wherein an optical axis distance of the second lens group is greater tian an optical axis distances of the first and third lens groups,
wherein a number of lenses of the third lens group is smaller than a number of lenses of the first lens group, and
wherein the third lens group includes a lens having a meniscus shape convex toward the sensor side and a lens having a meniscus shape convex toward the object side.

22. The optical system of claim 21, wherein the lenses of the first to third lens groups are made of plastic, and
wherein the lenses of the first to third lens groups have a smaller number of lenses with negative power than a number of lenses with positive power.

23. The optical system of claim 21, wherein optical axis distances of the first to third lens groups are DG1, DG2, and DG3,
wherein the following equations satisfy:
0.5<DG1/DG2<1
0.8<DG1/DG3<1.

24. The optical system of claim 21, wherein a lens having the largest absolute value of focal length among the first to third lens groups is disposed within the third lens group.

25. The optical system of claim 21, wherein an optical axis distance of the third lens group is DG3,
wherein an optical axis distance between a surface of a lens of the first lens group closest to the object side and an imaging surface of an image sensor is TTL, and
wherein the following equation satisfies:
2<TTL/(DG2+DG3)<5.

26. The optical system of claim 21, wherein an optical axis distance between a lens closest to an image sensor in the third lens group and the image sensor varies depending on the operation mode, and
wherein the operation mode of the optical system includes a wide mode, a middle mode, and a tele mode.

27. The optical system of claim 26, wherein an optical axis distance between an object-side surface of a lens closest to the object in the first lens group and a sensor-side surface of the lens closest to the image sensor in the third lens group varies depending on the operation mode, and
wherein an optical axis distance between the first and second lens groups and an optical axis distance between the second and third lens groups is at least 0.2 mm or more and at most 8 mm or less.

28. The optical system of claim 26, wherein the wide mode is Md1,
wherein the optical axis distance between the first and second lens groups in the wide mode is DG12,
wherein the optical axis distance between the second and third lens groups is DG23, and
wherein the following equation satisfies:
1<Md1(DG12/DG23)<5.

29. The optical system of claim 26, wherein the tele mode is Md3,
wherein the optical axis distance between the first and second lens groups is DG12, and the optical axis distance between the second and third lens groups is DG23 in the tele mode, and
wherein the following equation satisfies:
0<Md3(DG12/DG23)<0.7.

30. The optical system of claim 21, wherein a maximum distance between adjacent lenses in the operation modes is Md_CG_Max,
wherein a minimum distance between adjacent lenses in the operation modes is Md_CG_Min, and
wherein the following equation satisfies:
2<Md_CG_Max/Md_CG_Min<8.

31. The optical system of claim 21, wherein the number of lenses of the first lens group is greater than a number of lenses of the second lens group, and
wherein an absolute value of a focal length of the first lens group is more than twice a focal length of the second lens group.

32. The optical system of claim 26, wherein an effective focal length in the wide mode of the optical system is FMd1,
wherein a focal length of the first lens is F1, and
wherein the following equation satisfies:
5<F1/Fmd1<13.

33. The optical system of claim 26, wherein an effective focal length in the tele mode of the optical system is FMd3, and
wherein the following equation satisfies:
0<F1/Fmd3<0.6.

34. The optical system of claim 26, wherein a field of view in the wide mode is FOV1, a field of view in the middle mode is FOV2, a field of view in the tele mode is FOV3, and the following equation satisfies: 8°<FOV3<FOV2<FOV1<45°.

35. An optical system comprising:
a first lens group having first to third lenses;
a second lens group having fourth and fifth lenses; and
a third lens group having sixth and seventh lenses,
wherein the first lens group, the second lens group, and the third lens group are arranged in a direction of an optical axis from an object toward an image sensor,
wherein the first lens has positive refractive power and has a convex object-side surface on the optical axis,
wherein the third lens has negative refractive power and has a shape in which both sides are concave on the optical axis,
wherein the fifth and sixth lenses have refractive powers of opposite signs and have a meniscus shape convex toward the image sensor,
wherein the second lens group and the third lens group move in direction of the optical axis,
wherein an optical axis distance between the seventh lens and the image sensor varies depending on operation mode,
wherein the first to seventh lenses have a number of lenses having a refractive index exceeding 1.60 greater than a number of lenses having a refractive index less than 1.60,
wherein a refractive index of the second lens is Nd2, and
wherein the following equation satisfies:
1.65<Nd2.

36. The optical system of claim 35, wherein the first and third lens groups have negative refractive power, and
wherein the second and fourth lenses have positive refractive power.

37. The optical system of claim 35, wherein the fourth lens and the seventh lens have refractive indices of less than 1.6.

38. The optical system of claim 35, wherein a lens surface having a largest absolute value of a radius of curvature of an object-side surface and a sensor-side surface of each of the first to seventh lenses is the object-side surface of the third lens.

39. The optical system of claim 35, wherein an effective length of the first lens is the largest among the lenses,
wherein the first lens has different maximum lengths in a first direction and maximum lengths in a second direction perpendicular to the optical axis,
wherein an effective length of the largest lens surface among the first to seventh lenses is CA_Max,
wherein ½ of a diagonal length of the image sensor is ImgH, and wherein the following equation satisfies:
1<CA_Max/ImgH<3.

40. A camera module comprising:
an image sensor;
an optical system; and
a driving member that moves at least one of a plurality of lens groups of the optical system in a direction of the optical axis,
wherein the optical system includes an optical system according to claim 21, and
wherein the driving member moves positions of each of the second and third lens groups of the optical system in the direction of the optical axis.
